(19) United States
(12) Patent Application Publication
(10) Pub. No.: US 2026/0244904 A1
(43) Pub. Date: Aug. 20, 2026

(54) GENERATING, PRESENTING, AND EXECUTING HISTORICAL SOCIAL NETWORK FUNCTIONS

(71) Applicant: Ancestry.com Operations Inc., Lehi, UT (US)

(72) Inventors: Anne Gillespie Mitchell, Fremont, CA (US); Herrick Gordon Muhlestein, Ephraim, UT (US); Kaleb Benjamin White, Herriman, UT (US)

(21) Appl. No.: 19/537,999

(22) Filed: Feb. 12, 2026

Related U.S. Application Data
(60) Provisional application No. 63/760,638, filed on Feb. 20, 2025.

(51) Int. Cl. G06N 3/0475; G06Q 10/40

(52) U.S. Cl. CPC G06N 3/0475; G06Q 10/40

(57) ABSTRACT

The present disclosure is directed toward systems, methods, and non-transitory computer-readable media for generating and providing network functions tailored to a particular historical social network. In particular, the disclosed systems can receive historical-network contextual data from a client device. The disclosed systems can further retrieve genealogical content item(s) related to the historical-network contextual data. The disclosed systems further generate (e.g., using an LLM) network functions specific to the historical-network contextual data. The disclosed systems can further provide a visual representation of the network functions for display on the client device.

### CROSS-REFERENCE TO RELATED APPLICATIONS

This application claims priority to and the benefit of U.S. Provisional Patent Application No. 63/760,638, filed on Feb. 20, 2025, which is incorporated herein by reference in its entirety.

### BACKGROUND

Advancements in computing devices and networking technology have given rise to a variety of innovations in cloud-based genealogical data storage, sharing, and generation. For example, online historical-content systems can provide access to digital genealogical content items across devices all over the world. To facilitate such access, modern historical-content systems can provide search functions for sifting through large quantities of genealogical and other historical data to identify relevant genealogical content items, including birth certificates, digitized newspaper articles, images, census records, obituaries, and others. Despite these advances, however, existing systems continue to suffer from a number of disadvantages, particularly in terms of computational efficiency, flexibility, and accuracy.

As just suggested, many existing historical-content systems are computationally inefficient, or at least leave room for improvement in resource consumption and function execution. For instance, as just mentioned, some existing systems can provide search functions for sifting through large quantities of historical-content data to identify relevant genealogical content items. However, such existing systems frequently use rigidly programmed platforms with hyper-specific functions or web applications that perform single tasks and/or that often require users to have sophisticated knowledge to effectively operate. Indeed, many existing systems perform search functions using research software that is fragmented in nature, where each software application or web program is often rigidly programmed for its particular purpose.

Accordingly, to perform varied and complex tasks, such as historical social network research projects that necessarily require searching across a variety of databases containing different types of genealogical content items, such as Census records, birth, marriage, and death records, newspaper images, etc., existing systems often use outputs from one software application or web program as inputs for another software application or web program, sometimes requiring many applications at once for a single project. As part of their operation, such existing systems also frequently require users to navigate through a plurality of graphical user interfaces and applications—by, in many instances, running multiple applications in tandem—to find sought-for information. Running the various applications and processing the interactions for navigating among the applications, user interfaces, and devices utilizes excessive amounts of computational resources, such as processing power, memory, and storage. Moreover, this results in substantial inflexibility between parallel or adjacent software applications or web programs, as the techniques that yield to successful research in one software application or web program may translate poorly to another software application or web program.

Many existing systems for genealogical and/or historical network research have largely provided limited forms of assistance that place significant responsibility on the user. For example, many existing platforms operate as static repositories or basic search interfaces for historical records, family trees, and related data, requiring the user to independently determine what actions to take, which sources to consult, and how to interpret or reconcile retrieved information. These systems generally do not generate suggested functions, investigative steps, or research pathways, instead leaving users to manually navigate complex and often fragmented datasets without guided support. Other existing platforms merely provide generic suggested functions, irrespective of a particular genealogy tree and/or historical network, despite the vast differences in different types of historical networks and available associated data (e.g., based on the particular time period and/or location).

Moreover, some existing genealogical systems provide automated guidance, but only in a narrowly constrained manner based on limited inputs. For example, such systems may typically analyze structured genealogical trees and compare one tree to another to identify missing relationships, inconsistencies, or potential matches. The resulting suggestions are therefore restricted to filling gaps or resolving differences within existing tree data, without drawing on broader contextual information, unstructured historical records, or an understanding of historical networks. As a result, these systems lack the ability to generate adaptive, context-aware, or explanatory assistance that meaningfully supports the broader process of genealogical research.

A large-scale database such as user profile and genetic database can include billions of data records. This type of database may allow users to build family trees, research their family history, and make meaningful discoveries about the lives of their ancestors. Users may try to identify relatives with datasets in the database. However, identifying relatives in the sheer amount of data is not a trivial task. Datasets associated with different individuals may not be connected without a proper determination of how the datasets are related. Comparing a large number of datasets without a concrete strategy may also be computationally infeasible because each dataset may also include a large number of data bits. Given an individual dataset and a database with datasets that are potentially related to the individual dataset, it is often challenging to identify a dataset in the database to that is associated with the individual dataset.

Entity extraction is likewise an outstanding problem in the field. Only generic entity extraction has even been attempted, and this with disappointing results. For instance, it is difficult to apply a specific or specialized entity-extraction model to an article or a tree person without knowing the topic of the article. Further, names alone are difficult if not completely impossible to “stitch” or resolve with other entities in, e.g., a genealogical research database, as names lack contextual details that facilitate clustering and other entity-resolution techniques.

Generating research tasks is an enormously difficult challenge even when a family relationship with a particular person is known based on a plurality of evidences; for example, even where a pedigree—comprising nodes representing persons connected by edges representing family relationships—is well-established, it is a computationally demanding and technically challenging task to generate a next-person hint.

These along with additional problems and issues exist with regard to existing systems. In view of the foregoing, there is a need for improved historical-network generation and task-generation approaches.

### SUMMARY

This disclosure describes one or more embodiments of systems, methods, and non-transitory computer-readable storage media that provide benefits and/or solve one or more of the foregoing and other problems in the art. In particular, the disclosed systems utilize a large language model (LLM) to analyze contextual data for a historical social network and generate network functions to present to a client device. Specifically, the disclosed systems receive historical-network contextual data from a client device. For instance, the historical-network contextual data can include location(s), date(s), and identifier(s) for persons corresponding to the historical network. The disclosed systems can further retrieve genealogical content item(s) related to the historical-network contextual data and generate (e.g., using an LLM) network functions specific to the historical-network contextual data. The disclosed systems can further provide a visual representation of the network functions for display on the client device.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIGS. 1-11 illustrate different embodiments of systems, methods, and/or computer-program products configured for generating historical network research functions according to the present disclosure and components for use therewith.

The drawing figures are not necessarily drawn to scale, but instead are drawn to provide a better understanding of the components, and are not intended to be limiting in scope, but to provide exemplary illustrations. The drawing figures, which are included to provide a further understanding of the disclosure, are incorporated in and constitute a part of this specification, illustrate embodiments of the disclosure and together with the detailed description serve to explain the principles of the disclosure.

No attempt is made to show structural details of the disclosure in more detail than may be necessary for a fundamental understanding of the disclosure and various ways in which it may be practiced. The figures illustrate exemplary configurations of systems, methods, and/or computer-program products configured for generating historical-network research tasks, and in no way limit the structures, configurations, or functions of systems and methods for to systems, methods, and/or computer-program products configured for generating historical-network research tasks, and components thereof, according to the present disclosure.

The figures depict various embodiments for purposes of illustration only. One skilled in the art will readily recognize from the following discussion that alternative embodiments of the structures and methods illustrated herein may be employed without departing from the principles described herein.

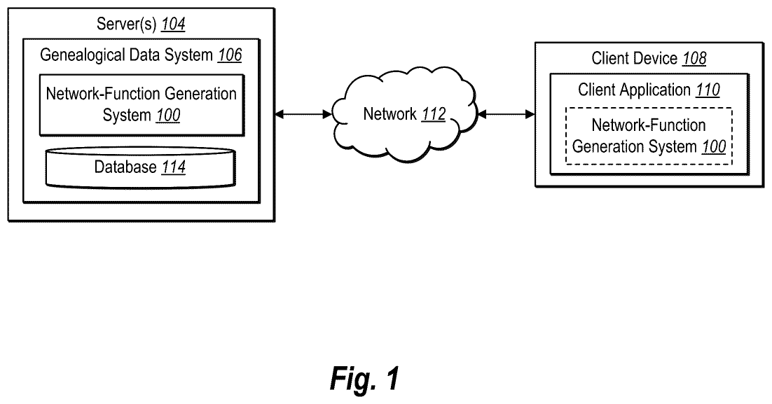

FIG. 1 illustrates a schematic diagram of an example environment of a network-function generation system in accordance with one or more embodiments.

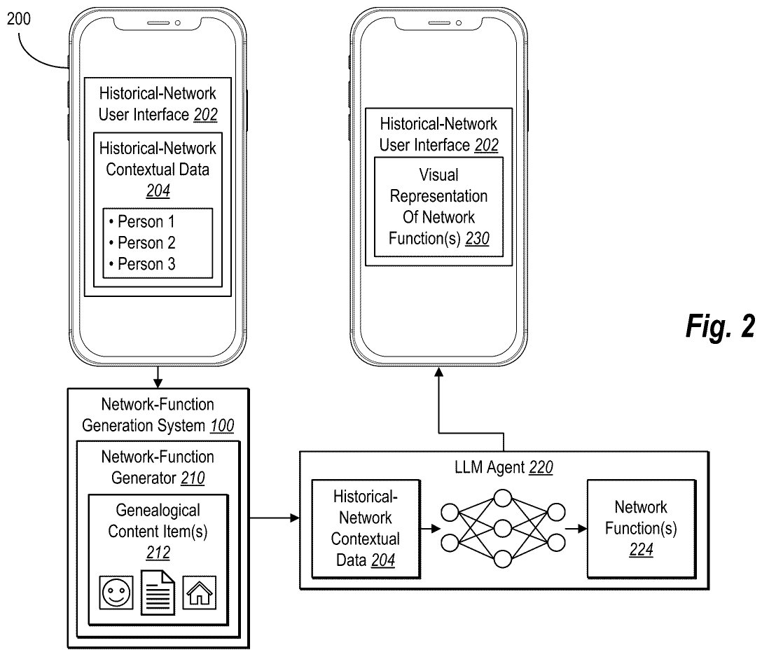

FIG. 2 illustrates an example diagram of an overview of a network-function generation system generating network function(s) and providing a visual representation thereof in accordance with one or more embodiments.

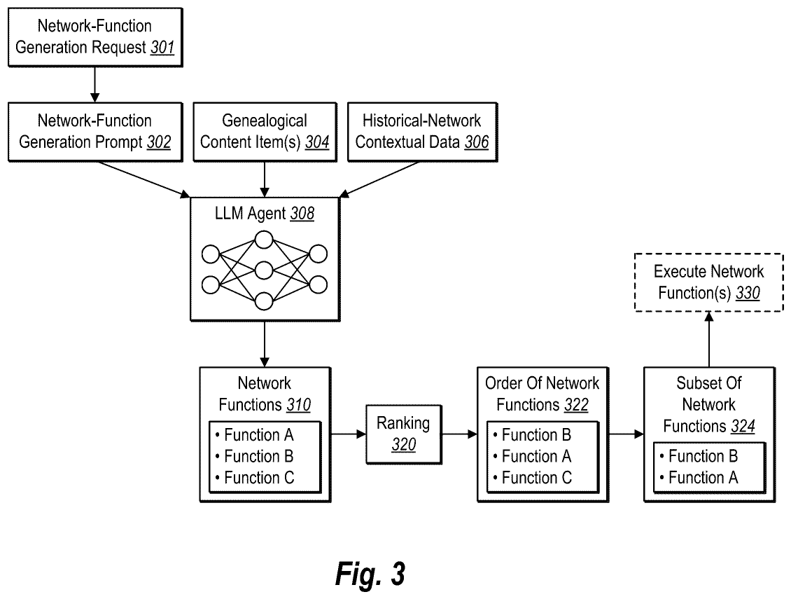

FIG. 3 illustrates a schematic diagram of a network-function generation system generating a plurality of network functions based on historical-network contextual data, in accordance with one or more embodiments.

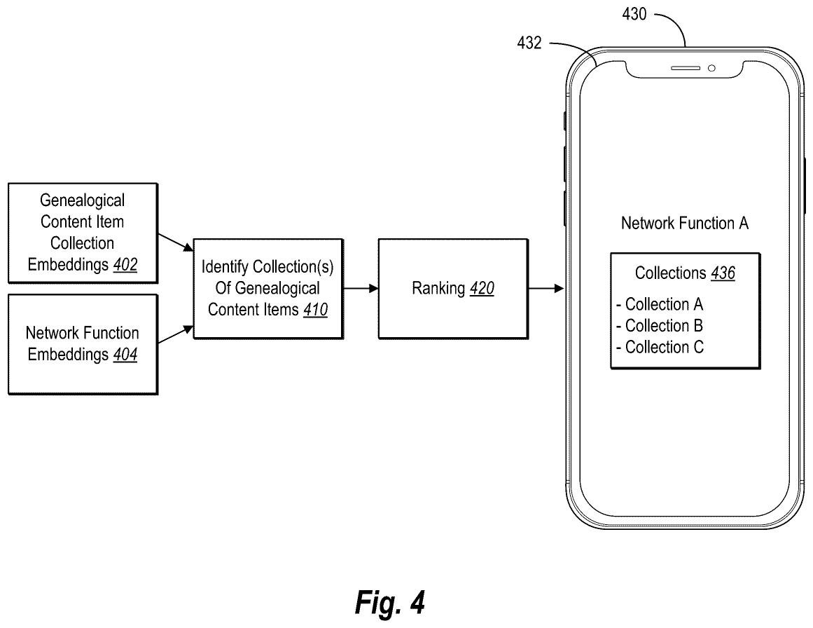

FIG. 4 illustrates a schematic diagram of a network-function generation system identifying and providing one or more collections of genealogical content items relevant to network functions, in accordance with one or more embodiments.

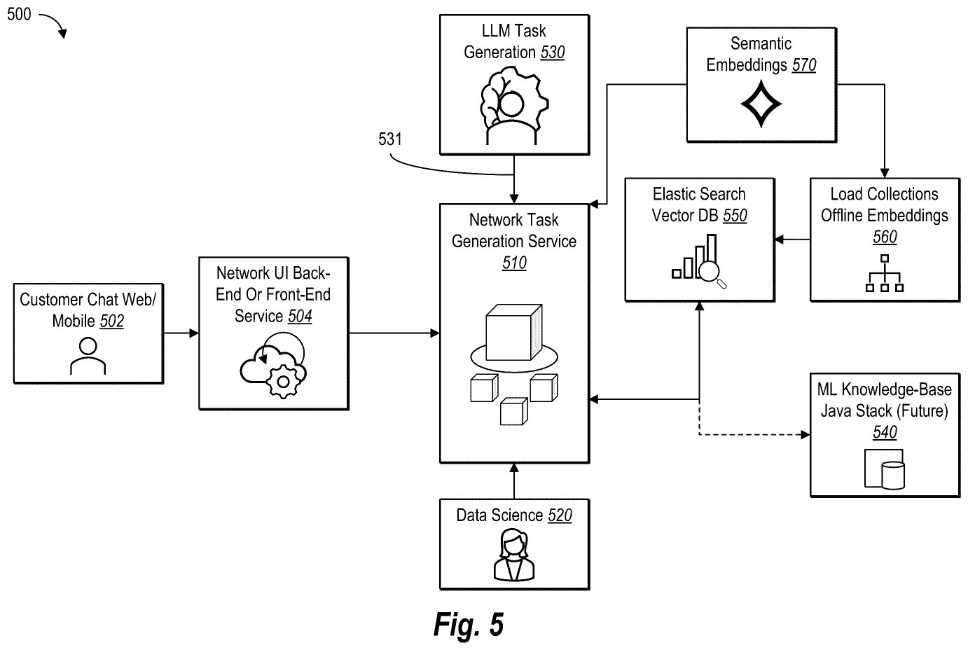

FIG. 5 illustrates a schematic diagram of a system for network-task generation, in accordance with one or more embodiments.

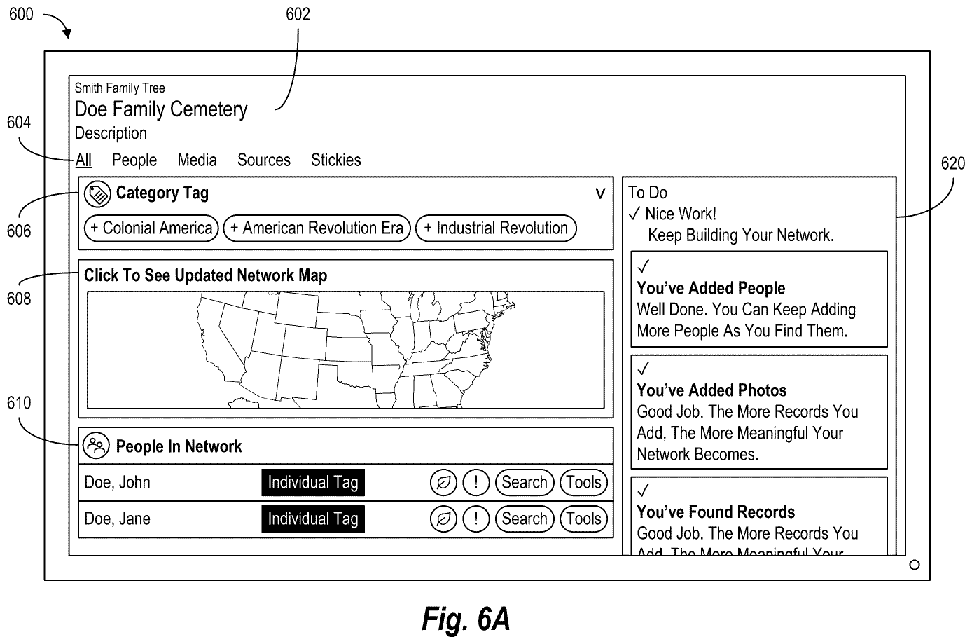

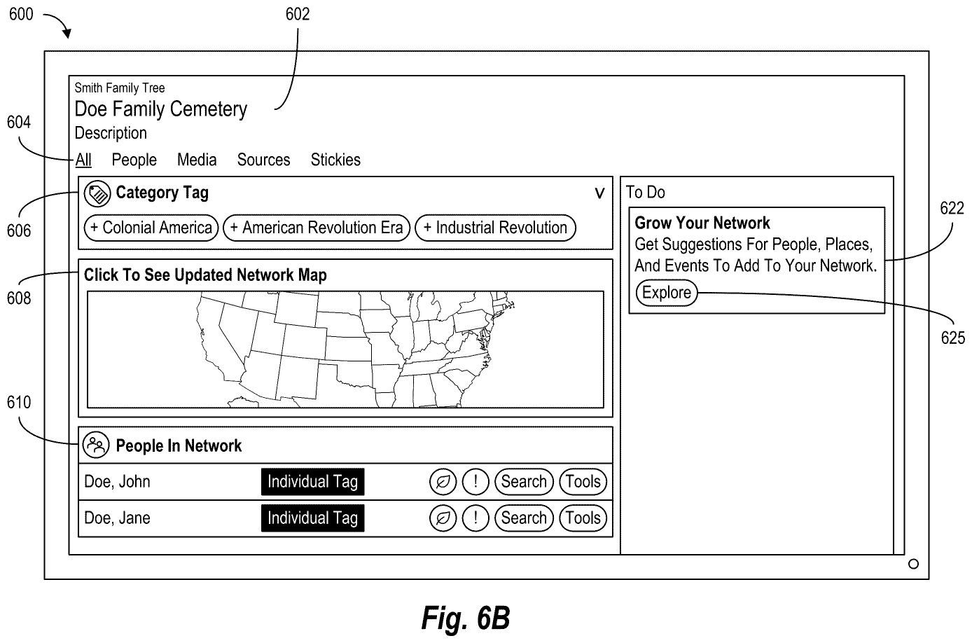

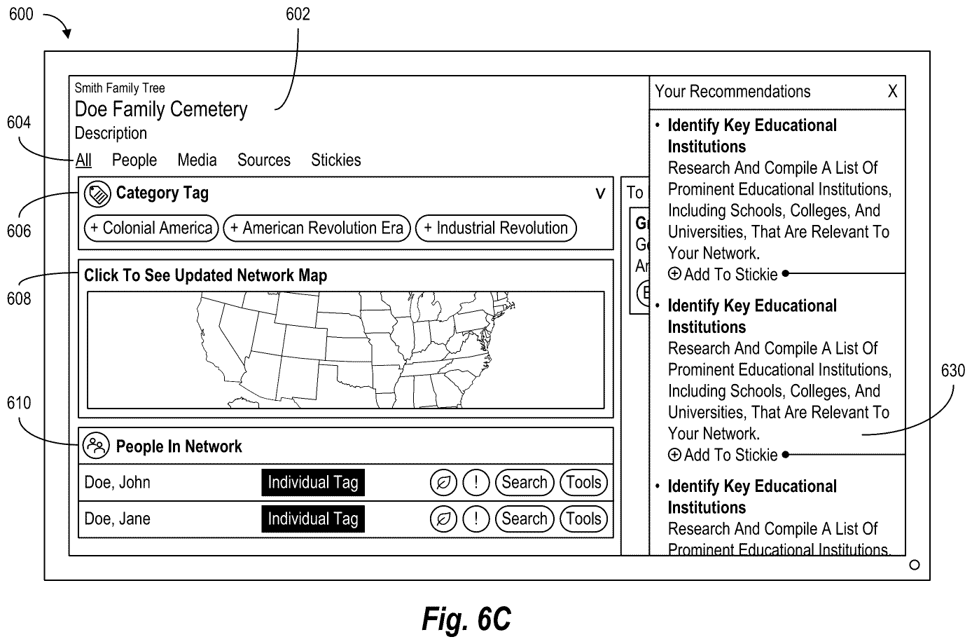

FIGS. 6A-6C illustrate example graphical user interfaces of the network-function generation system providing and displaying generated suggestions for network functions (e.g., network tasks), in accordance with one or more embodiments.

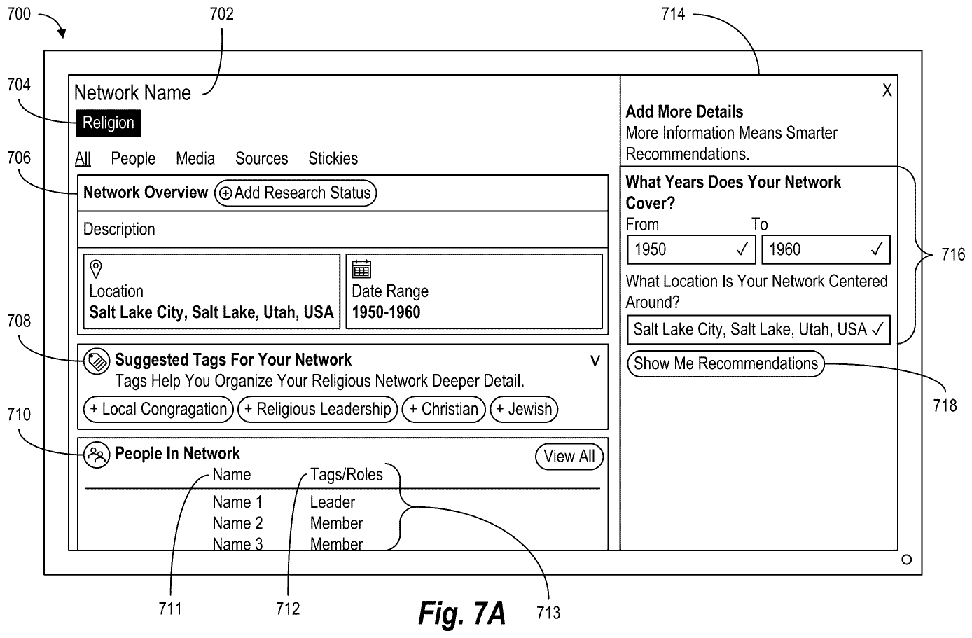

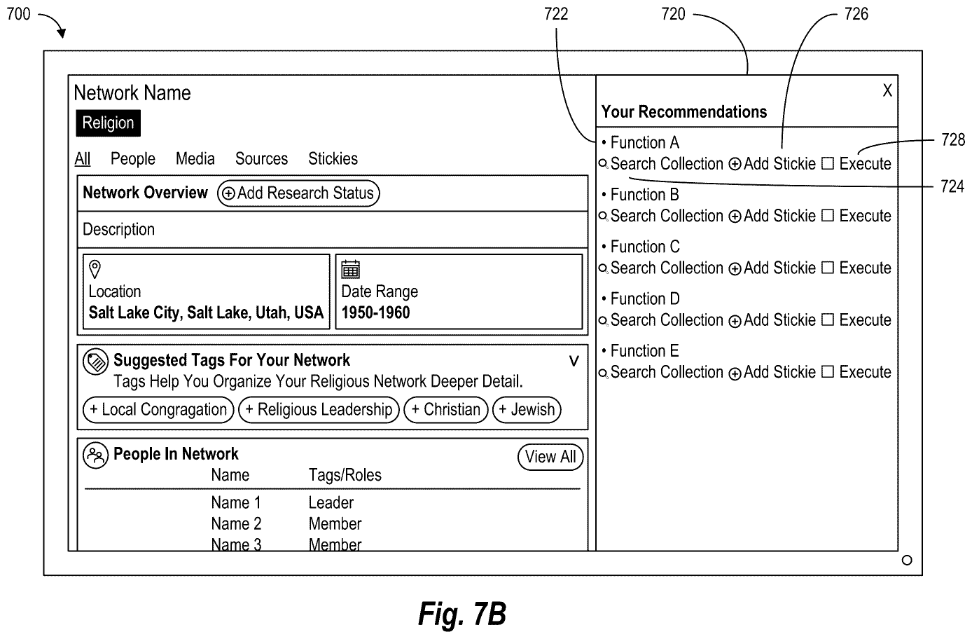

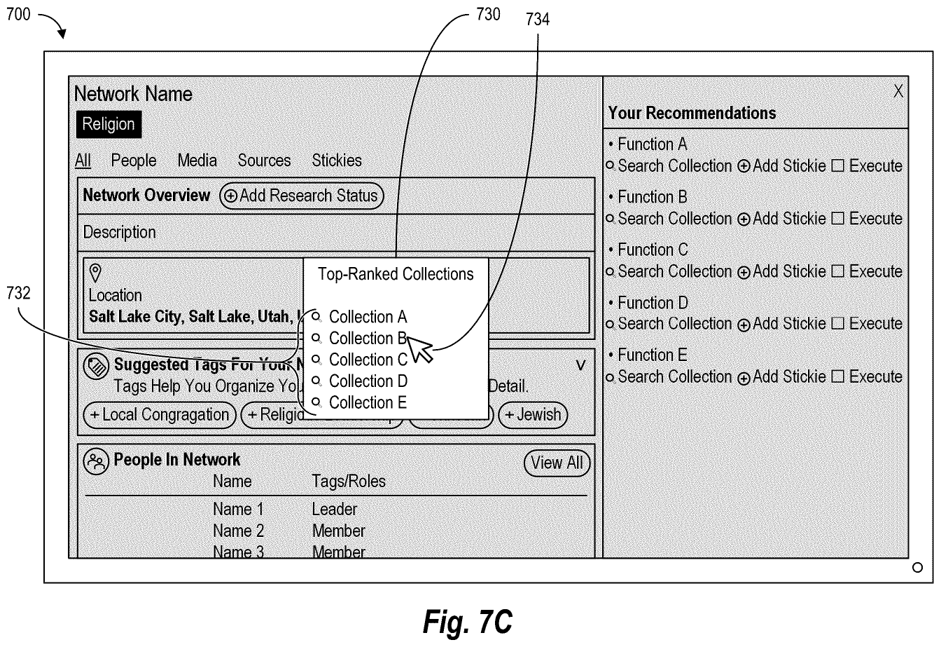

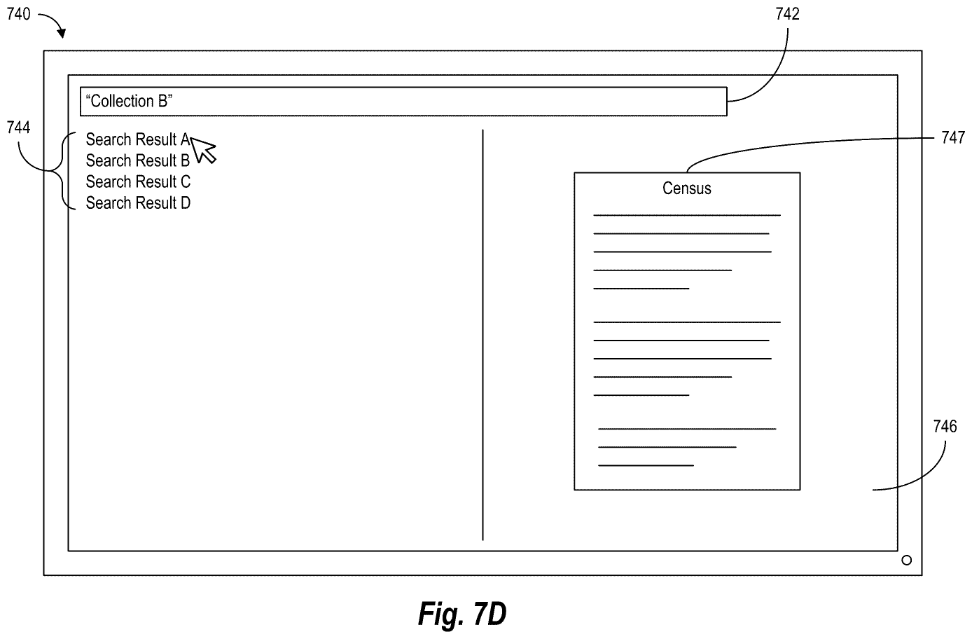

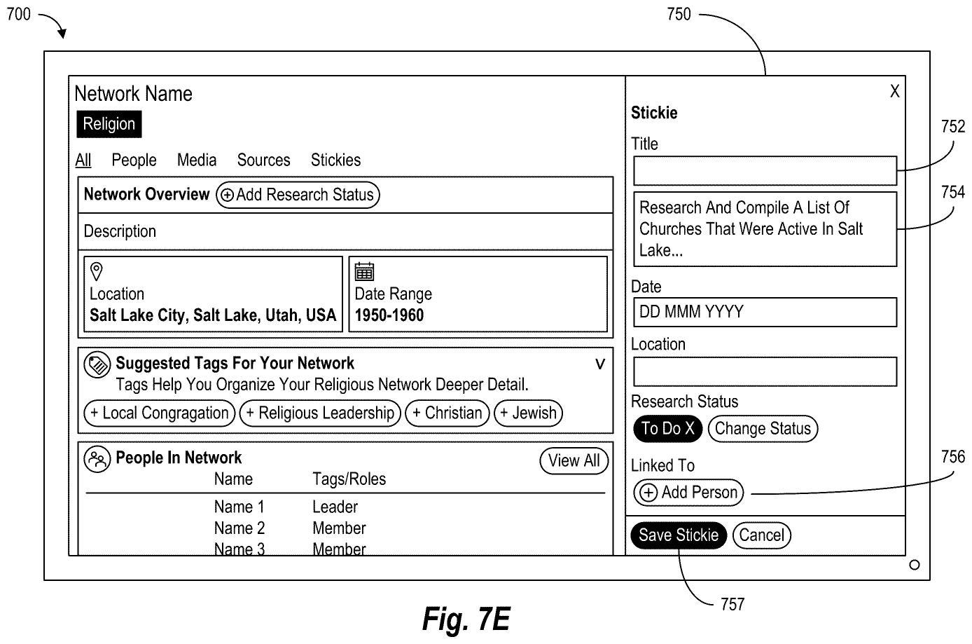

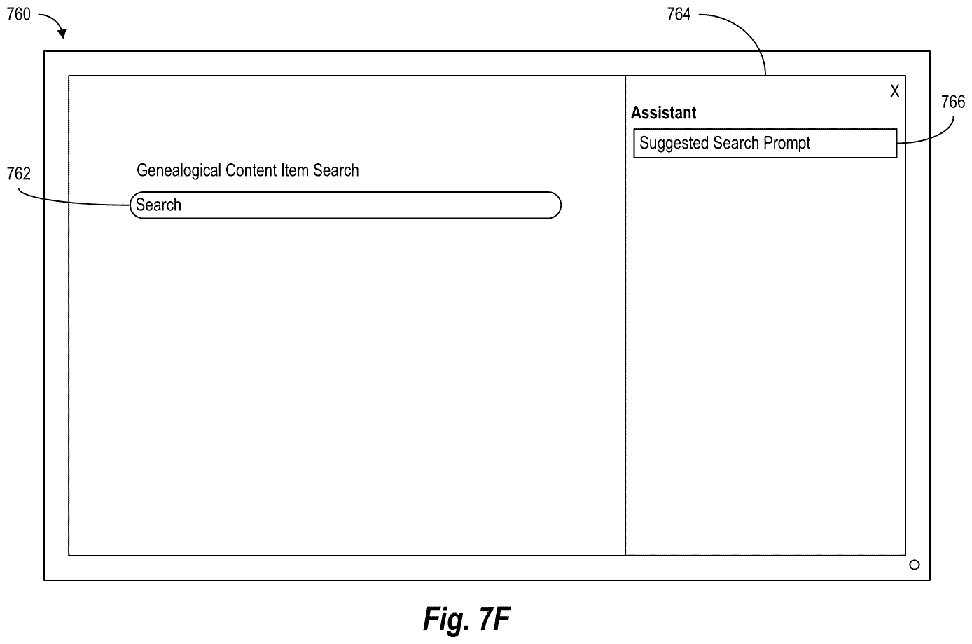

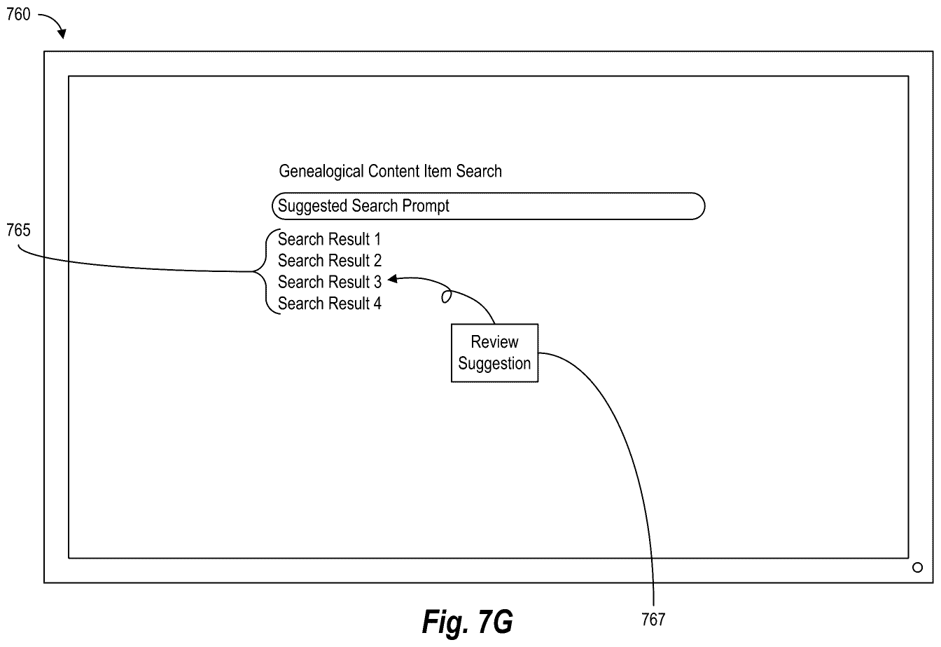

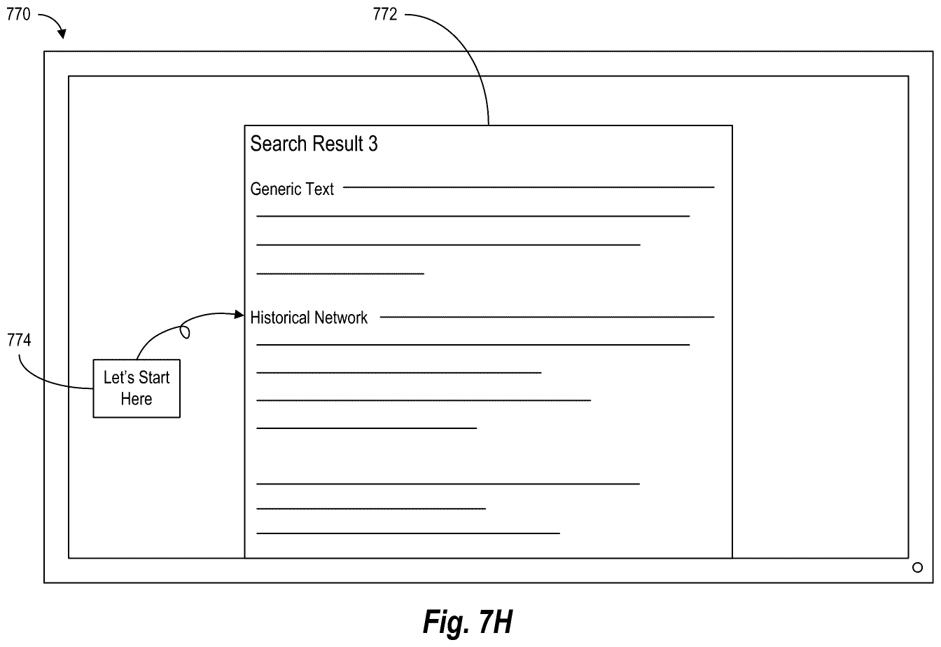

FIGS. 7A-7H illustrate example graphical user interfaces of the network-function generation system providing and executing network functions, in accordance with one or more embodiments.

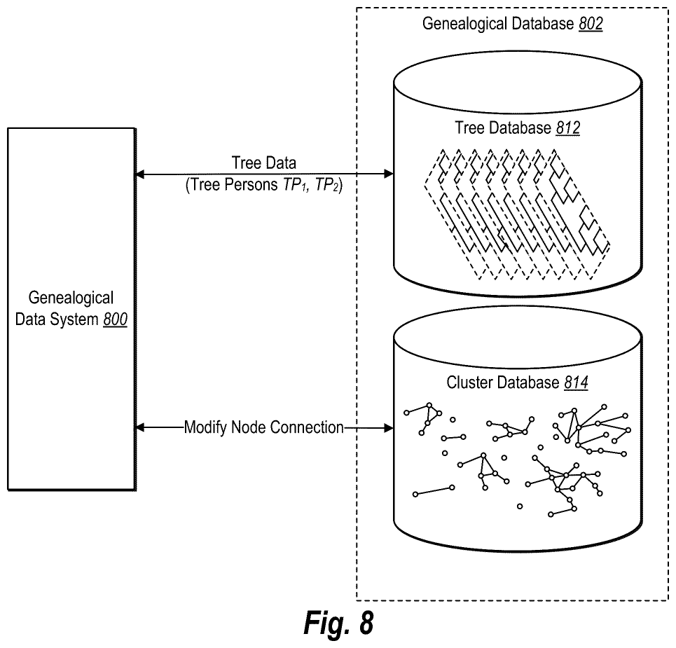

FIG. 8 illustrates a tree database and a cluster database of the network-function generation system in accordance with one or more embodiments.

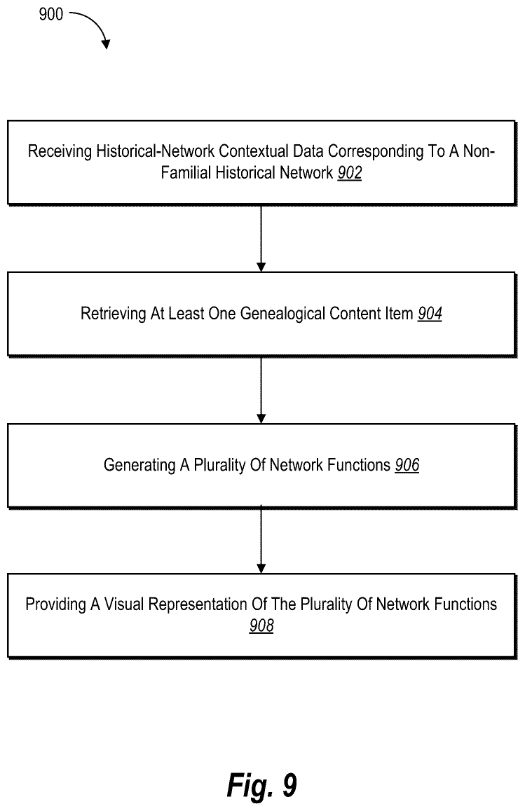

FIG. 9 illustrates an example series of acts for providing a visual representation of a plurality of network functions in accordance with one or more embodiments.

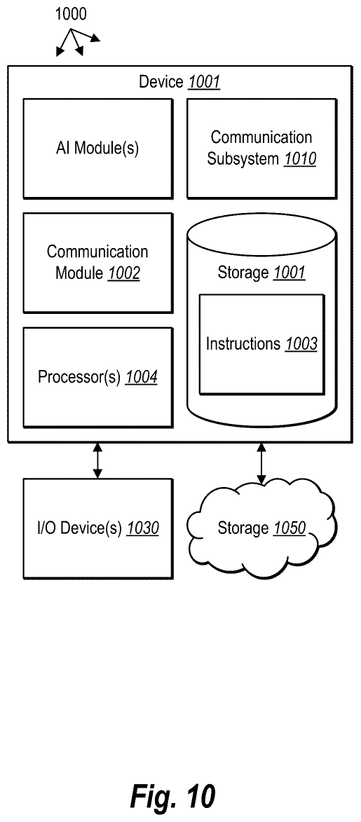

FIG. 10 illustrates an exemplary computing system in accordance with one or more embodiments.

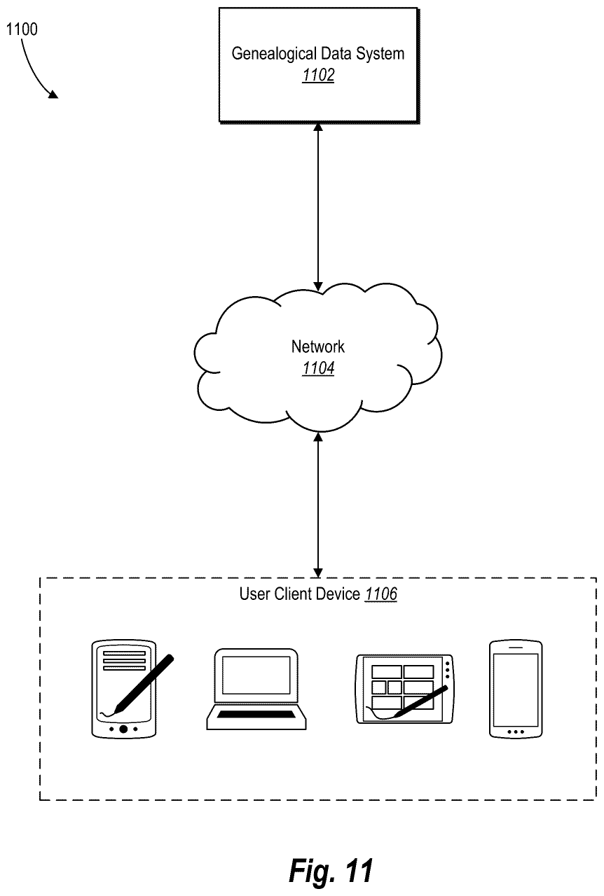

FIG. 11 illustrates an exemplary computing environment in accordance with one or more embodiments.

### DETAILED DESCRIPTION

This disclosure describes one or more embodiments of a network-function generation system that can assist in historical network research by generating and providing, in a historical-network user interface, a visual representation of network functions that are tailored to contextual data for the historical network. For example, the network-function generation system can receive historical-network contextual data from a client device via a historical-network user interface. Based on the historical-network contextual data received from the client device, the network-function generation system can retrieve relevant genealogical content items from a store of genealogical content items. Using a large language model, the network-function generation system can generate network functions specific to the historical network and provide a visual representation of the same for display on the client device (e.g., as hints or prompts to modify a genealogy tree and/or promote further genealogical research).

In particular, in some embodiments, the network-function generation system generates the network functions as informed by retrieved content items, in addition to historical-network contextual data. In some embodiments, the network-function generation system retrieves relevant collection(s) of genealogical content items and provides a visual representation of the relevant collection(s) for display. For example, in some cases, the network-function generation system retrieves collection(s) of genealogical content items based on relevance to a generated network function, e.g., by comparing vector representations of a network function to vector representations of collections of genealogical content items. The network-function generation system can provide visual representations of the collection(s) of genealogical content items through the historical-network user interface to further facilitate execution of the network functions.

Furthermore, in some cases, the network-function generation system ranks generated network functions based on relevance to accomplishing a target objective for the historical network. For instance, the network-function generation system can rank the network functions based on relevance to identifying additional persons and other historical data corresponding to the historical network. Additionally, in some embodiments, the network-function generation system can automatedly execute network functions. Thus, the network-function generation system can generate and provide tailored recommendations (and/or can otherwise execute tasks to modify genealogical tree nodes, generate hints, or perform other tasks) for historical network research functions in an intuitive interface that is accessible and understandable even to novice users.

As suggested above, the genealogical agentic system provides several improvements over conventional systems. For example, the network-function generation system can improve accuracy over prior systems. For instance, in contrast to prior systems that may provide a) no suggested functions, b) generic suggested functions, or c) functions based on merely comparing genealogical trees, the network-function generation system generates network functions tailored to a particular historical network using a LLM to parse historical-network contextual data. Rather than providing overgeneralized assistance for researching a historical network as in some prior systems, the network-function generation system can generate network functions related to specific attributes of a historical network. Additionally, in some cases, the network-function generation system identifies and retrieves collections of content items related to these specialized network functions. Thus, the network-function generation system can provide historical-network user interfaces with more accurate recommendations compared to systems that provide generalized recommendations, leading to more accurate determination of historical-network data (e.g., identification of additional persons belonging to the historical network and/or other data associated with the historical network). In turn, by improving the accuracy of historical networks, the network-function generation system improves the accuracy of genealogical research (e.g., by using the improved historical social networks as an additional data source for further genealogical research).

Furthermore, the network-function generation system improves efficiency relative to existing systems. For instance, in contrast with the disjointed structure of existing systems that result in excessive navigational inputs and excessive use of computational resources (such as processing power and memory) processing such navigational inputs, the network-function generation system can generate and provide visual representations of network functions (and in some cases, relevant collection(s) of genealogical content items) in a single, consolidated historical-network user interface. Prior systems often require users to navigate across numerous interfaces to manually determine network functions, search genealogical content items and to implement various web-based research tools to determine pertinent historical data for a historical network. Compared to these prior systems, the network-function generation system thus more seamlessly automates (portions of) historical network research processes by generating and providing visual representations of network functions tailored to a historical network. In some cases, the network function(s) efficiently drive the progression of historical-network research tasks and/or provides structured assistance, decision-making processes, and/or automation capabilities. Additionally, by generating a network function that is tailored to historical-network contextual data, the network-function generation system can guide a user in a historical-network research process without requiring excessive time or navigational inputs via a client device painstakingly wading through various databases, records, and/or tools.

As another example of technical improvements, the genealogical agentic system can improve operational flexibility over prior systems. For example, the network-function generation system uses the network functions to adapt the application and accessibility of historical network research systems to a wider range of user accounts. The network-function generation system thus facilitates complex historical network research tasks even for novices or others without sophisticated understanding of the various models involved in a historical network research workflow. Indeed, unlike prior systems that require expert knowledge of available functions and strategies to perform a historical network research workflow (e.g., that involves multiple models and/or interconnected steps), the network-function generation system automatedly generates specific network functions tailored to the current progress of a historical network research workflow and interface elements to display and facilitate execution of such network functions.

As illustrated by the foregoing discussion, the present disclosure utilizes a variety of terms to describe features and benefits of the genealogical agentic system. Additional detail is hereafter provided regarding the meaning of these terms as used in this disclosure. Further, while this disclosure focuses primarily on genealogical content in the context of a genealogical data system, the network-function generation system can perform one or more of the processes described herein in the context of other types of digital content items and data systems as well.

As used herein, the terms “non-familial historical network,” “historical social network,” “non-familial historical network,” and “historical network” refer to a collection, data structure, graph, or other computable representation that models relationships among historical entities based on historical data. In some embodiments, a historical network can include a plurality of nodes representing historical persons, groups, organizations, locations, events, or other historical entities, and a plurality of edges representing relationships, associations, interactions, or shared attributes among those entities. Such relationships can include, by way of example and not limitation, social or community affiliations, religious affiliations, organizational memberships, co-occurrence within historical records, shared participation in historical events, geographic proximity over time, or other inferred or explicit historical connections. In some embodiments, a historical network is non-familial in the sense that it is not based on familial relationships, though it may include historical entities that happen to have a familial relationship.

As used herein, the term “historical-network user interface” refers to a user interface used to present and collect data related to a historical network. For example, a historical-network user interface can provide interactive visual elements to collect data regarding the historical network from a client device. The historical-network user interface can further include other visual interface elements to represent the historical network. In some embodiments, a historical-network user interface can provide visual representations of network functions, status of network functions, and interactive elements selectable to generate network functions.

As used herein, the term “historical-network contextual data” refers to user-input and/or system-generated parameters or other data associated with a historical network. For instance, historical-network contextual data can include, for example, identifiers (e.g., names) of persons, date(s), geographic location(s), role(s), classification(s), tag(s), type(s), etc. associated with the historical network. In some cases, historical-network contextual data can be interpretable by a large language model to inform generation of one or more network functions.

As used herein, the term “identifier” refers to a value, label, or data object used by a computing system to identify an entity within a historical network. For example, an identifier can be associated with a node representing a historical entity and can be used to reference, store, retrieve, link, or disambiguate that entity across historical records, genealogical content items, databases, or system components. In some embodiments, an identifier comprises a name or by a representation derived from one or more names, including a personal or organizational name, a normalized or canonicalized form of a name, a name variant, or a name-based key, alone or in combination with additional attributes such as dates, locations, or record identifiers. In other embodiments, an identifier comprises an alphanumeric string, numeric value, hash, pointer, uniform resource identifier, or other encoded representation, e.g., derived from one or more names. An identifier can be system-generated, user-provided, or derived from historical data, and may remain persistent across sessions or be resolved dynamically at runtime. In some cases, multiple identifiers may be associated with a single historical entity to account for name variations, aliases, transliterations, or differing source systems.

As used herein, the term “network function” refers to a segment of computer code or a subroutine that is executable by a processor to generate, from input data, an output related to a historical network. For example, a network function may be guidance that includes one or more hints, assistance, suggestions, recommendations, directions, and/or an automated execution for a user account to, for example, consider, accept (or reject), address, follow, interact with, and/or execute. For instance, a network function can refer to system-generated suggestion, recommendation, proposal, request for review, or automated execution of a search for one or more genealogical content items, or other research-related operation, related to a historical network. In some embodiments, a network function refers to a task item for a research process involving a historical network (e.g., a historical-network research task). In some embodiments, a function applies (or calls) a particular model (e.g., a search model) or Application Programming Interface (“API”), executes a heuristic code segment, generates a notification for display on a client device, extracts specific data from one or more databases, and/or the like.

As used herein, the term “network-function generator” refers to a model (e.g., machine learning model) for generating network functions based on contextual data. For example, a network-function generator can generate network functions for a historical network based on historical-network contextual data. In some embodiments, a network-function generator includes or is connected to a large language model (LLM).

As used herein, the term “genealogical content item” (or sometimes simply “content item”) refers to a digital object or a digital file that includes information (e.g., genealogical and/or other historical information) interpretable by a computing device (e.g., a client device) to present information to a user. A content item can include a file such as a digital text file, a digital image file, a digital audio file, a webpage, a website, a digital video file, a web file, a link, a digital document file, or some other type of file or digital object. A content item can have a particular file type or file format, which may differ for different types of digital content items (e.g., digital documents, digital images, digital videos, or digital audio files). In some cases, a content item can refer to a genealogical content item that includes or depicts historical or genealogical information, such as a birth certificate, a digitized newspaper article, a digitized photograph of a relative, a digitized census record, a digitized obituary, a digitized court document, a digitized DNA analysis, or a digitized family tree. In some embodiments, a genealogical content item includes a content item selected or identified to surface to a client device, such as an item in a response, a record hint (e.g., a stored or generated genealogical content item surfaced as a suggestion for a user account), a digital story (e.g., a stored collection of genealogical content items arranged for a particular person, topic, or entity of a genealogical data system), a digital image (e.g., a digitized photograph), a new person hint (e.g., a suggested node to add to a genealogical tree), a member tree hint (e.g., a prediction for correcting a node within a genealogical tree of a user account), or a DNA match (e.g., a record indicating a DNA match of a user account to a relative whose information is stored in a genealogical data system).

In addition, as used herein, the term “machine learning model” refers to a computer algorithm or a collection of computer algorithms that automatically improve for a particular task through iterative outputs or predictions based on use of data. For example, machine learning model can utilize one or more learning techniques to improve in accuracy and/or effectiveness. Example machine learning models include various types of neural networks, decision trees, support vector machines, and Bayesian networks. In some embodiments, the genealogical agentic system utilizes a large language machine learning model in the form of a neural network.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., responses, data for passing to downstream models, and/or content items) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network. Upon training as described below, such a neural network may become a large language model that generates responses to prompts by interpreting prompt language, accessing additional data from content items, and executing functions indicated by prompts and/or content items.

Further, as used herein, the term “large language model” refers to a machine learning model trained to perform computer tasks to generate or identify content items in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate model outputs (e.g., content items, summaries, or query responses) and/or to identify content items based on various contextual data, including graph information from a knowledge graph and/or historical user account behavior. In some cases, a large language model comprises a LLaMA model or a GPT model such as, but not limited to, ChatGPT and its variants.

Additional detail regarding the genealogical agentic system will now be provided with reference to the figures. For example, FIG. 1 illustrates a schematic diagram of an example system environment for implementing a network-function generation system 100 in accordance with one or more implementations. An overview of the network-function generation system 100 is described in relation to FIG. 1. Thereafter, a more detailed description of the components and processes of the network-function generation system 100 is provided in relation to the subsequent figures.

As shown, the environment includes server(s) 104, a client device 108, a database 114, and a network 112. Each of the components of the environment can communicate via the network 112, and the network 112 may be any suitable network over which computing devices can communicate. Example networks are discussed in more detail below in relation to FIGS. 10-11.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 10-11. The client device 108 can communicate with the server(s) 104 and/or the database 114 via the network 112. For example, the client device 108 can receive user input from respective users interacting with the client device 108 (e.g., via the client application 110) to, for instance, provide a user query as part of a historical-network research workflow and/or to search for, access, generate, modify, or share a genealogical content item and/or to interact with a historical network, genealogical tree, a content item via a graphical user interface of the genealogical data system 106. In addition, the network-function generation system 100 on the server(s) 104 can receive information, such as a query relating to various searches for, or interactions with, genealogical content items, and/or user interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface such as a historical-network user interface, a genealogical research interface, a genealogical tree interface, a discover interface for discovering additional genealogical content or discovering relationships among existing genealogical content, or some other graphical user interface, as described herein.

As illustrated in FIG. 1, the example environment also includes the server(s) 104. The server(s) 104 may generate, track, store, process, receive, and transmit electronic data, such as genealogical content items, network functions, collections of genealogical content items, prompts, generated responses, and/or interactions with content items. For example, the server(s) 104 may receive data from the client device 108 in the form of a user query and/or a request to modify a historical network, to modify a genealogy database, to modify a genealogical tree, and/or to perform a search for a genealogical content item or collection of genealogical content items. In addition, the server(s) 104 can transmit data to the client device 108 in the form of a response (e.g., network function and/or other data generated by a large language model) within a graphical user interface. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the network-function generation system 100 as part of a genealogical data system 106. The genealogical data system 106 can communicate with the client device 108 to perform various functions associated with the client application 110 such as managing user accounts, managing genealogical data, managing historical networks, managing genealogical trees, managing genealogical content items, managing genetic data (e.g., genomes and other DNA-related data) for individuals, and facilitating user interaction with, and sharing of, the genealogical trees, genealogical content items, and genetic data. Indeed, the genealogical data system 106 can include a network-based cloud storage system to manage, store, and maintain genealogical content items, historical social networks, and genealogical trees related data user accounts. For instance, the genealogical data system 106 can utilize genealogical data across various content items and user accounts to generate and maintain a universal genealogical tree that reflects the relatedness or consanguinity between nodes corresponding to all user accounts and other individuals indicated by stored genealogical content items. In some embodiments, the network-function generation system 100 and/or the genealogical data system 106 utilize the database 114 to store and access information such as genealogical content items, genealogical trees, user account data, and/or other information.

As further illustrated in FIG. 1, the genealogical data system 106 includes a database 114 that stores genealogical content items and/or other data, such as historical social network data. In particular, the network-function generation system 100 stores and processes the genealogical content items and historical social network data to generate network functions. For instance, the network-function generation system 100 receives an input from the client device 108 and generates a plurality of network functions that relate to genealogical content items (including collections of genealogical content items. In some embodiments, the database 114 also includes a repository of prompts that instruct or inform a large language model for performing particular tasks, including generating network functions based on genealogical content items and historical social network data.

Although FIG. 1 depicts the network-function generation system 100 located on the server(s) 104, in some implementations, the network-function generation system 100 may be implemented by (e.g., located entirely or in part on) one or more other components of the environment. For example, the network-function generation system 100 may be implemented in whole or in part by the client device 108. For example, the client device 108 and/or a third-party system can download all or part of the network-function generation system 100 for implementation independent of, or together with, the server(s) 104.

In some implementations, the environment may have a different arrangement of components and/or may have a different number or set of components altogether. For example, the client device 108 may communicate directly with the network-function generation system 100, bypassing the network 112. As another example, the environment may include multiple client devices, each associated with a different user account. In addition, the environment can include the database 114 located external to the server(s) 104 (e.g., in communication via the network 112) or located on the server(s) 104 and/or on the client device 108.

As mentioned above, the network-function generation system 100 can generate network function(s) based on a historical social network, and provide a visual representation of the network function(s) to a client device. FIG. 2 illustrates an example overview of the network-function generation system 100 receiving historical-network contextual data corresponding to a plurality of persons of a non-familial historical network, retrieving at least one genealogical content item, generating network function(s), and providing a visual representation of the network function(s), in accordance with one or more embodiments. Additional detail regarding the various acts and processes introduced in relation to FIG. 2 is provided thereafter with reference to subsequent figures.

As illustrated in FIG. 2, the network-function generation system 100 can receive historical-network contextual data 204 from a client device 200 (e.g., as entered or input via a historical-network user interface 202). The historical-network contextual data 204 can include contextual data corresponding to a non-familial historical network. By way of non-limiting example, the non-familial historical network can model historical social, geographic, community, educational, military, religious, and other relationships between historical entities (e.g., non-living persons).

To further illustrate, the historical-network contextual data 204 can include date(s), location(s), classification(s), description(s), and identifier(s) corresponding to the historical network and/or entiti(es) belonging to the historical network. For instance, at least some of the historical-network contextual data 204 can correspond to a plurality of entities (e.g., persons) of the non-familial historical network. For example, the historical-network contextual data 204 can include names of such persons.

As mentioned, the network-function generation system 100 can provide the historical-network user interface 202 for display and can receive, from the client device 200, data corresponding to the historical network, including the historical-network contextual data 204. In some instances, the historical-network user interface 202 includes interactive interface elements to receive the historical-network contextual data 204. Additional detail regarding receiving the historical-network contextual data 204 from the client device 200 via the historical-network user interface 202 is provided below with reference to subsequent figures. In addition, the network-function generation system 100 can receive contextual data regarding the historical network in other ways. For example, the network-function generation system 100 can also receive system-generated contextual data regarding the historical network and contextual data derived from historical data (e.g., derived from one or more genealogical content items).

To illustrate, in an exemplary embodiment, the network-function generation system 100 receives historical-network contextual data identifying that a non-familial historical network relates to a particular geographic location (“North Carolina”), a particular date range (“1900-1920”), a particular classification (“religious”), and including a historical network description and a set of identifiers for persons corresponding to the non-familial historical network. For example, the network-function generation system 100 receives the historical-network contextual data from a client device displaying a historical-network user interface.

As illustrated in FIG. 2, the network-function generation system 100 can provide the historical-network contextual data 204 to a network-function generator 210. In some embodiments, the network-function generation system 100 retrieves, via the network-function generator 210, one or more genealogical content items 212 related to the historical-network contextual data 204. For example, the network-function generator 210 can retrieve the one or more genealogical content items 212 by performing a search of genealogical content items stored within a cluster database, based on the historical-network contextual data 204.

In some embodiments, the network-function generation system 100 retrieves one or more collections of content items related to the historical-network contextual data 204. For example, the network-function generation system 100 can identify one or more collections of genealogical content items relevant to the historical-network contextual data 204, based on for example, embeddings. Additional detail regarding retrieving one or more collections of content items related to the historical-network contextual data 204 is provided below with reference to subsequent figures.

In some embodiments, the network-function generator 210 can further retrieve additional contextual data based on the cluster database and/or a connected tree database, for example, additional contextual data corresponding to entities within the historical network (e.g., tree-persons identified in the historical-network contextual data 204).

As further illustrated in FIG. 2, based on the historical-network contextual data 204, the network-function generation system 100 can further generate one or more network functions 224 using a LLM agent 220 associated with the network-function generator 210. For example, the network-function generation system 100 can provide the historical-network contextual data 204 to the LLM agent 220, optionally along with the one or more genealogical content items 212. The network-function generation system 100 can process the historical-network contextual data 204 to determine the one or more network functions 224.

In some implementations, the one or more network functions 224 include suggestions for functions to implement related to the historical network, tailored to the historical-network contextual data 204. For example, the network-function generation system 100 can generate, using the LLM agent, specific search suggestions or proposals for searches for genealogical content items relevant to the historical-network contextual data 204. As another example, the network-function generation system 100 can identify (e.g., by selecting among the one or more genealogical content items 212), a subset of genealogical content item for further review and/or that are relevant to the historical-network contextual data 204. In some embodiments, the network-function generation system 100 generates the one or more network functions 224 further based on the one or more genealogical content items 212. Additional detail regarding the LLM agent 220 is provided below with reference to subsequent figures.

Returning to the exemplary embodiment discussed above, given the historical-network contextual data, the network-function generation system 100 generates network functions related to: identifying religious denominations in North Carolina in 1900-1920, locating church records for identified denominations, cross-referencing religious records with census data, reviewing records for religious schools in North Carolina during 1900-1920, and analyzing religious publications and newsletters.

Additionally, while in the example of FIG. 2, the network-function generation system 100 is illustrated as retrieving the one or more genealogical content items 212 before generating the one or more network functions 224, in some cases, the network-function generation system 100 retrieves the one or more genealogical content items 212 and generates the one or more network functions 224 simultaneously, and/or retrieves the one or more genealogical content items 212 based on the one or more network functions 224. For example, the network-function generation system 100 can further retrieve at least one genealogical content item related to the historical-network contextual data by identifying a collection of genealogical content items related to a network function and retrieving the collection (optionally, based on receiving further input from the client device). For example, in the exemplary embodiment discussed above, based on the generated network function related to cross-referencing religious records with census data, the network-function generation system 100 can identify a compilation of census records from North Carolina covering the 1900-1920 time period.

Having generated the one or more network functions 224, the network-function generation system 100 can proceed to provide, for display on the client device 200, a visual representation 230 of the one or more network functions 224. For example, the network-function generation system 100 can provide the visual representation 230 using the historical-network user interface 202. For example, the visual representation 230 can include text, images, description, interactive interface elements, and other visual features related to the one or more network functions 224.

As previously mentioned, the network-function generation system 100 can generate a plurality of network functions based on historical-network contextual data. FIG. 3 illustrates an exemplary overview of the network-function generation system 100 processing historical-network contextual data with an LLM agent to generate a plurality of network functions, and ranking the plurality of network functions to determine an order of network functions and a subset of network functions, in accordance with one or more embodiments.

As shown in FIG. 3, the network-function generation system 100 receives a network-function generation request 301. For instance, the network-function generation system 100 can receive the network-function generation request 301 from a client device displaying a historical-network user interface (e.g., the client device 108 and the historical-network user interface 202). In some embodiments, the network-function generation system 100 receives the network-function generation request 301 by receiving user input selecting an interface element of the historical-network user interface 202 (e.g., a button). In some embodiments, the network-function generation system 100 receives the network-function generation request 301 through an LLM-based chat interface included in or overlaid on the historical-network user interface 202 (e.g., as a natural-language query).

As further illustrated, based on receiving the network-function generation request 301, the network-function generation system 100 generates a network-function generation prompt 302. For example, the network-function generation prompt 302 can include instructions to generate a plurality of network functions relevant to the historical-network contextual data 306. The network-function generation prompt 302 can further include instructions to rank network functions and/or select a subset of the generated network functions, as will be further described below.

In some embodiments, the network-function generation system 100 provides the network-function generation prompt 302, one or more genealogical content items 304, and historical-network contextual data 306 to an LLM agent 308. As mentioned, the historical-network contextual data 306 can include, for example, geographic location(s), date(s), name(s)/other identifier(s) for tree node persons, description(s), title(s), and classification(s) corresponding to the historical network. As mentioned, in some embodiments, the historical-network contextual data 306 is received from a client device associated with a user account for which the network-function generation system 100 is generating the network functions. For example, the network-function generation system 100 can provide interface elements in the historical-network user interface and receive historical-network contextual data 306. In some embodiments, the historical-network contextual data 306 (or a portion thereof) is received from a client device associated with another, different user account. For example, the historical-network contextual data 306 can be received from a client device associated with a first account, and a historical-network user interface is provided to a client device associated with a second account.

Additionally, in some cases, at least a portion of the historical-network contextual data 306 is system-generated based on, e.g., genealogical content item(s). For example, the network-function generation system 100 can previously infer and/or extract contextual data from genealogical content items related to the historical network. Methods for generating historical social network data based on historical data records are further described in U.S. patent application Ser. No. 19/304,977 filed Aug. 20, 2025 and entitled “Determining Relationships of Historical Data Records,” which is hereby incorporated by reference in its entirety.

As mentioned, in some embodiments, the network-function generation system 100 provides the one or more genealogical content items 304 to the LLM agent 308. The one or more genealogical content items 304 can include, for example, the one or more genealogical content items 212 retrieved by the network-function generator 210. The one or more genealogical content items 304 can further include, for example, genealogical content items that have been associated with the historical network based on user input received from a client device (e.g., the client device 108) displaying a historical-network user interface (e.g., the historical-network user interface 202).

As illustrated, the network-function generation system 100 can process the network-function generation prompt 302, the one or more genealogical content items 304, and the historical-network contextual data 306 using the LLM agent 308. The network-function generation system 100 generates, using the LLM agent 308, network functions 310 specific to the historical network. For example, in the example of FIG. 3, the LLM agent 308 generates “Function A”, “Function B”, and “Function C.”

The network-function generation system 100 can further perform a ranking 320 of the network functions 310, wherein the network-function generation system 100 ranks the network functions 310 using the network-function generator 210 and/or the LLM agent 308 associated with the network-function generator 210. Based on the ranking 320, the network-function generation system 100 determines an order of network functions 322. For example, FIG. 3 illustrates the network-function generation system 100 determining to order the network functions as Function B, Function A, and Function C.

For instance, the network-function generation system 100 can rank the network functions 310 based on relevance to the historical-network contextual data 306 and/or relevance to the one or more genealogical content items 304. In some cases, the network-function generation system 100 ranks the network functions 310 based on relevance to accomplishing a target objective for the historical network. For instance, the network-function generation system can rank the network functions 310 based on relevance to (e.g., likelihood of) identifying additional persons and other historical data corresponding to the historical network (e.g., by execution of the network functions 310). In some embodiments, the network-function generation system 100 ranks the network functions 310 based on relevance to a subset of the historical-network contextual data, e.g., based on relevance to a subset of identifiers corresponding to particular persons of the historical-network contextual data.

In some cases, the network-function generation system 100 ranks the network functions 310 to identify an order of network functions that, when executed in sequence, accomplish a network target objective (e.g., a goal or intent of the historical network research workflow). For example, the LLM agent 308 can order the network functions 310 based on a logical, sequential flow between network functions that build upon one another. For example, the network-function generation system 100 can order network functions in an exemplary sequence—performing a search for a set of genealogical content items, reviewing the set of genealogical content items, identifying from the set of genealogical content item additional entities associated with the historical network, adding the additional entities to the historical network, performing a second search based on the additional entities, and so forth—to facilitate an exemplary overall network target objective of identifying further members belonging to the historical network.

As illustrated in FIG. 3, the network-function generation system 100 can further identify a subset of network functions 324. For example, the network-function generation system 100 can identify the top n network functions based on the ranking 320, and/or network functions having a relevance score over a threshold. The network-function generation system 100 can further identify the subset of network functions 324 based on constraints of the client device (e.g., size of display), format of the historical-network user interface, and other considerations. The network-function generation system 100 can generate and provide a visual representation the subset of network functions 324 for display on the client device.

As further illustrated in FIG. 3, network-function generation system 100 can further perform an act 330 of executing one or more network functions. For example, the network-function generation system 100 can execute the one or more network functions upon receiving further input from the client device. Additionally or in alternative, in some embodiments, the network-function generation system 100 can automatedly execute one or more network functions. For example, in some cases, the network-function generation system 100 can use the LLM agent 308 together with one or more executable function adapters to carry out network function(s). For example, the network-function generation system 100 can determine, according to the one or more network functions, executable function adapter(s) from among a plurality of candidate executable function adapters to perform the one or more network functions.

As used herein, the term “function adapter” refers to computer code executable to perform one or more functions as instructed by a large language model. In particular, a function adapter may refer to computer code (e.g., a process or subroutine) that can adapt a large language model to its task or context by extracting data from relevant databases (e.g., by executing calls to APIs) and/or which can facilitate completion of tasks external to the genealogical autonomous-decision framework (e.g., by executing calls to APIs). In some cases, a function adapter is a set of heuristics (e.g., logical rules or programmed subroutines), a neural network (e.g., a large language model), or a combination thereof which can execute tasks, call APIs, and/or extract data for adapting nodes. Additionally, in some embodiments, a function adapter can include or otherwise perform one or more functionalities of a geographic information system that maps specific types of data and/or specific types of data requirements to a specific geographic location. Further, in one or more embodiments, the network-function generation system 100 utilizes function adapters as described in GENEALOGICAL AUTONOMOUS-DECISION FRAMEWORK, U.S. patent application Ser. No. 19/174,550, filed Apr. 9, 2025, which is incorporated herein by reference in its entirety.

As mentioned, the network-function generation system 100 can identify and provide one or more collections of genealogical content items relevant to network functions. FIG. 4 illustrates an example overview of the network-function generation system 100 identifying a collection of genealogical content items relevant to a network function and providing a visual representation of the collection of genealogical content items for display on the client device, in accordance with one or more embodiments.

As illustrated in FIG. 4, the network-function generation system 100 can access genealogical content item collection embeddings 402 for collections of genealogical content items. For example, the genealogical content item collection embeddings 402 can be previously generated and stored in the database 114.

As further illustrated in FIG. 4, the network-function generation system 100 can generate network function embeddings 404 based on a network function from the plurality of network functions generated by the LLM agent. To illustrate, the network-function generation system 100 can access a network function. For example, the network-function generation system 100 can convert the network function to embeddings (e.g., vector representations) to generate the network function embeddings 404. For example, the network-function generation system 100 can execute an API call to generate, for the network function, the network function embeddings 404, e.g., using an embeddings model.

As illustrated in FIG. 4, the network-function generation system 100 can further perform an act 410 of identifying collection(s) of genealogical content items. For example, the network-function generation system 100 can execute a vector search of the network function embeddings 404 against a database of the genealogical content item collection embeddings 402 to retrieve collection(s) of genealogical content items. For instance, the network-function generation system 100 can compare the genealogical content item collection embeddings 402 with network function embeddings 404 (e.g., by determining distances between the embeddings in embedding space).

As further illustrated, the network-function generation system 100 can generate a ranking 420 of collections (and/or of individual items) of genealogical content items. For example, the network-function generation system 100 can rank (e.g., using the network-function generator), the identified collection(s) of genealogical content items based on relevance to the network function. For example, the network-function generation system 100 can rank the collections of genealogical content item based on a confidence level or a closeness of the collection(s) of genealogical content item (e.g., of vector representations of the collection(s) of genealogical content item) to the network function (e.g., vector representation of the network function) in vector space.

The network-function generation system 100 can further select a subset of retrieved collections of genealogical content items based on the ranking 420. For example, the network-function generation system 100 can select the top n collection(s) of genealogical content item based on the ranking 420.

Returning to FIG. 4, the network-function generation system 100 can provide a visual representation 436 of a ranked list of the one or more collections of genealogical content items, for display on the client device 430. For example, the network-function generation system 100 can provide the visual representation 436 as part of the historical-network user interface 432 (e.g., integrated into the historical-network user interface 432 or overlaid on the historical-network user interface 432). In some embodiments, the visual representation 436 includes interactive interface elements that, when selected, cause the network-function generation system 100 to provide the collection of genealogical content items for display on the client device 430, and/or provide a search interface for a search related to the collection of genealogical content items.

As mentioned, in some embodiments, the disclosed systems, methods, and computer-program products facilitate the generation of network functions (for example, historical-network research-tasks). For example, a network-task generation service receives a plurality of names of potentially related persons potentially comprising a historical network via a user interface and provides the received plurality with at least an engineered prompt and a retrieved record to an LLM module. The network-task generation service ranks a plurality of received network-specific research-task suggestions from the LLM to output a ranked list of tasks specific to a subset of the plurality of names.

Embodiments of historical-network research-tasks generation systems and methods address shortcomings in the art by generating research tasks and hints pertinent to a historical network, such as a historical social network. The research tasks may include a list of tasks generated based on a plurality of individuals determined to constitute or be related to each other through a historical network. For example, the embodiments may facilitate the provision of a list of individuals to a historical-network research-tasks generation module which may determine that the individuals constitute or are related to each other through a previously unknown historical network; to determine a research status of the identified, previously unknown historical network; and, based on the determined research status, to generate research tasks pertinent to the identified, previously unknown historical network.

The previously unknown historical network may comprise a historical social network comprising individuals associated with each other not necessarily based on familial ties but rather on associative ties, such as being members of a same military unit in a same military event, belonging to a same church, belonging to a same neighborhood, or otherwise. This absence of familial ties-which are more commonly documented in available historical records such as censuses, military draft records, birth, marriage, and death records, newspaper announcements, and other records-necessarily makes the determination, by the embodiments, that individuals are affiliated through a historical network an orders-of-magnitude more-complex task than determining a relationship between family members. For instance, family members follow hierarchical and relatively predictable relationship patterns from generation to generation with names, ages, and relationships well-documented in government and other record sources.

As such, determining that an individual-identified through a census record that shows the individual's name in a same household as a predicted relative along with relationship titles like “son,” “daughter,” etc. and ages that are suggestive of, e.g., parent-child relationships—is related to a particular predicted relative a comparatively straightforward task. By contrast, it is no small task to determine that a plurality of individuals-who are not co-listed on a plurality of government records along with labels suggesting a particular relationship therebetween and who are not affiliated through edges of pertinent clusters of a genealogical cluster database, said edges suggesting a particular relationship between the connected clusters/individuals—are in fact affiliated through a historical network, to determine the extent of historical research that is or could be done relative to said historical network, and to prioritize for a user a particular one or more tasks related to as-yet undone historical research for the historical network. Rather, identifying specific research tasks pertinent to a group of not-obviously-related persons is a monumental technical feat and a computational-resourcing nightmare.

The disclosed embodiments advantageously facilitate the identification or determination of such historical networks between not-obviously-related persons, and, based on an identification of a degree or extent of historical research extant relating thereto, identification of one or more particular tasks performable by a user by providing a networks-task generation module configured to receive, as input, one or more details regarding a potential network; to determine, using a networks-task generation large language model or other AIML modality, a degree of historical research regarding the potential network; and to output, e.g. for display on a graphical user interface of a user device, one or more suggested research tasks for the potential network.

The network-tasks generation-task large language model (“network-tasks generation LLM”) may be specially configured or trained for receiving input pertaining to a historical network, such as names of persons believed by a user to be affiliated through a non-familial historical network, and to compare the same against one or more records, to determine research tasks. In embodiments, a specialized application programming interface (“API”) is provided to receive, as input, one or more of the input shown in Table 1 below:

TABLE 1

| Name | Description |
|---|---|
| ID | |
| Title | Network Title (e.g., assigned by user) |
| Task Count | Number of Research Tasks to Generate |
| Collection | Max Number of Collections per Task |
| Count | |
| Categories | Categories and Subcategory Strings |
| Locations | List of Locations with, e.g., Country, |
| | State, County, City |
| StartYear | Starting Year Related to Network |
| EndYear | Ending Year Related to Network |
| LLM Override | Optional LLM Override (e.g., specification |
| | of different LLM than default LLM) |
| LLMArgs | Arguments Specific to LLMs |

In an embodiment, the networks task-generation LLM may receive one or more of the above inputs and, responsive to the input, identify, from, e.g., a genealogical research database, one or more record collections, genealogical trees, tags, locations, or other resources for assessment of a historical network. In embodiments, an LLM may be called and fed the input, such as the above-mentioned network input and/or the retrieved materials (such as record collections), with a suitable engineered prompt to generate, from the input, a list (a default number of tasks is five) of tasks pertinent to the alleged network and in view of the existing retrieved materials. The tasks may be generated based on a likelihood of successful research given the extant resources that may elucidate details about the alleged or potential network and/or based on an extent of retrieved, already completed research on aspects of the alleged or potential network. Any suitable LLM, such as Claude 3.5 Sonnet, Claude 3.5 Haiku, ChatGPT 40, ChatGPT 40 mini, or any other suitable LLM may be utilized as suitable.

For example, in response to input regarding an alleged, potential network for “York County Land Owners,” with a specified location for York county South Carolina, with a start year of 1850 and 1860, the API may provide the input details for the alleged network along with pertinent resources—such as Census records, land-title records, established pedigrees, and other records or resources pertinent to the time and location—to a default or selected LLM module to generate a response with a default or specified number of tasks, such as “Identify Key Individuals in Census Records,” “Research census records from 1800 to 1850 to identify individuals listed as landowners in York County,” etc., along with one or more pertinent collections identified as being potentially relevant. For example, the record collections may include enumeration districts located in and around York county for Censuses in the early to mid 19th century.

As seen in FIG. 5, a system 500 for network-task generation may include a “customer chat web/mobile” user interface 502 configured to cooperate with a network UI backend 504. The network UI backend 504 may be configured, in turn, to provide, from the user interface 502, input such as the network title and description, user specifications regarding LLMs, etc., to a network-task generation service 510, which may be a purpose-built back-end stack. The network-task generation service 510 may be configured to utilize an LLM module 530 connected via a ML service framework 531 to provide prompts and input and to receive, in turn, an LLM-generated response.

In an embodiment, for each task, a search may be performed using a vector database 550, which may utilize embeddings 560, 570 to generate, identify, and/or return one or more collections (e.g., genealogical records collections) to the network-task generation service 510 for providing to the user via the user interface 502. A data science module 520 may be provided for generating engineered prompts for the network-task generation service 510 to feed to the LLM module 530 along with one or more inputs received at the user interface 502.

While in embodiments, a collection of specific tasks and optionally related record collections may be returned to the user by the network-task generation service 510, in embodiments, the network-task generation service 510 is configured to perform one or more of the identified research tasks for the user. So in an exemplary network comprising York county landowners from 1850 to 1860, the network-task generation service 510 performs research regarding one or more of the individuals originally identified as part of the potential network, or if no individual names are provided as part of the potential network, the network-task generation service 510 determined based on the network title and/or other details that individuals associated with land ownership in York county during the specified time frame should be identified for the user or other users of the network. Thus the network-task generation service 510 may access a genealogical tree database, a cluster database, a records database, or a combination thereof to determine residence in the specified location and time and to identify records such as land deeds or census details that are suggestive of home or land ownership, with duplicate entities resolved and resulting hints ranked and prioritized and pared prior to providing to users.

In embodiments, the network-task generation service 510 is configured to receive input such as network title, network members in the form of tree persons or genealogical tree nodes, record(s) indicating a particular network (such as a military regiment muster order or a church roll or a class photo) and to identify a historical network therefrom by determining, e.g. using a call to the LLM module 530, that the individuals share a nexus. In embodiments, the LLM is prompted using, e.g., a particular set of instructions for non-familial network generation, and/or the LLM accesses the embeddings databases 560, 570 and/or a knowledge base 540 to inform its response generation. Thus the LLM is enabled by the particularized configuration of the system 500 to perform a computationally demanding and technically challenging task of assessing how a plurality of seemingly unrelated historical individuals were affiliated with each other.

Too, the network-task generation service 510 is configured in embodiments to, upon determining that a plurality of seemingly unrelated historical individuals were affiliated with each other, determine an extent of historical research that has been performed thereregarding. For instance, the network-task generation service 510 may be configured to call a profile of the determined or potential network and to provide the same as input to the LLM module 530, such that the LLM module 530 can determine (based additionally on the engineered prompt) to prioritize tasks, connections, and individuals that are not currently represented in the profile of the potential network but that are identifiable via the accessed embeddings databases 560, 570 and/or the knowledge base 540.

In an embodiment, a user selects an option via the network profile on the user interface to “generate tasks.” This advantageously preserves computational resources by not generating tasks until the user is interested in the results, but it will be appreciated that the disclosure is not limited thereto; rather, the task-generation process may be performed automatedly, on demand, or on any suitable basis. It has been found that the provision of on-demand tasks generated according to the disclosed embodiments advantageously improves user engagement therewith.

In an embodiment, the network-task generation service 510 is configured to receive, whether via the user interface 502 or from another service, a list of individuals purported to be part of a historical network, and is tasked with generating on behalf of users interested in the purported network insights regarding the affiliations between the individuals of the list of individuals. For instance, the network-task generation service 510 may receive the list of individuals and facts associated with the tree-person nodes that represent or correspond to the individuals and/or facts associated with records associated with the tree-person nodes. For instance, a cluster database wherein distinct tree nodes are resolved together based on determined consanguinity along with related records may be accessed to retrieve, and provide to the LLM module 530, records and tree nodes and related facts—such as birth, marriage, and death dates and locations, family relationships, etc. This advantageously leverages the extent and connectedness of the cluster database to provide an orders-of-magnitude greater degree of context with which the LLM module 530 may work, in conjunction with the engineered prompts from the data science module 520, to extract insights on behalf of users of a genealogical search service.

While in embodiments, input to the network-task generation service 510 includes details about a user-generated network such as network title, date range, etc., in embodiments a plurality of tree nodes representing people who are not related by blood but who are plausibly affiliated via a historical network are provided to or identified by the network-task generation service 510, with engineered prompts and pertinent records, media, or other resources identified as suitable. The LLM module 530 is configured and utilized to identify affiliations between the plurality of people, with the network-task generation service 510 being configured to receive from the LLM a plurality of network-specific research tasks based on the identified affiliations. The network-task generation service 510 may be further configured to rank and prioritize the received plurality of network-specific research tasks to identify a subset of the plurality of people and to recommend research tasks specific thereto. The identified subset may be a subset determined based on the ranking and prioritization to be a most-promising cohort of the plurality. It has been found that this advantageously reduces computational resources by prioritizing a subset of generated network-specific research tasks based on a subset of the pertinent plurality of people, thereby putting substantial downward pressure on computational resources overall.

The identification, using the network-task generation service 510 and the LLM module 530, advantageously allows for the identification of a particular combination of proverbial, not-obviously-related needles out of an unfathomably large stack of needles; whereas identification in the past of social affiliations between unrelated people relied upon serendipitous discoveries by professional genealogical researchers and historians, the embodiments facilitate the resource-efficient democratization of such discoveries by providing a novel architecture that leverages a combination of novel knowledge bases, collections, cluster database, and other resources to ascertain at will affiliations that are orders of magnitude more complex and less intuitive than family bonds, which follow archetypal patterns. Social affiliations, by contrast, do not lend themselves to such readily discernable relationships. Thus the people-specific research tasks generated by the embodiments solve previously insurmountable problems in the field of genealogical and historical research.

In embodiments, the input from the user interface comprises not a list of user-supplied or -specified names but rather a user-generated content item such as a group photo, such as a class photo from a yearbook. The network-task generation service may be configured to apply modalities such as a historical-faces recognition cluster database to identify historical persons in the image and to provide, to the LLM module, records and facts retrieved from a cluster database relating to the identified historical persons for determination of an affiliation between the historical persons.

Turning now to FIG. 6A, an example user interface 600, corresponding to the user interface 502 of FIG. 5, is shown and described. The user interface 600 may comprise a summary section 602 including a name, a description of the network (which may be user-added or automatedly generated), a linked pedigree, and/or other suitable details. The user interface 600 may be navigable by options 604, which may include sections for “People,” “Media,” “Sources,” and/or “Stickies” or “Notes,” as the case may be. Such sections may appear together in a default “All” section.

A category section 606 may include one or more selectable tags representing categories that the network pertains to. Such categories may include, in the example of the “Doe Family Cemetery,” “Colonial America,” “American Revolution Era,” “Industrial Revolution,” etc. Any number of suitable tags may be selected by the user or automatedly determined by the embodiments for a particular network. For example, a user may browse a catalog of available tags, a top-ranked list of categories may be detected by the embodiments based on a title, description, members, attached media, sources, or other information in the network.

A map 608 may be generated for the network based on locations, such as birth locations, associated with members of the network, based on a user-defined location for the network, or using any other suitable approach. For example, the embodiments may access a genealogical tree database and/or a cluster database to retrieve data associated with network members. Thus as a user adds additional members to the network in the form of tree persons, data associated with clusters to which the tree persons have been resolved by the cluster database, such as location data like birth locations, may be retrieved for populating within the map 608.

A people section 610 may provide in a list format or any other suitable format a plurality of members of the network. The people section 610 may be populated with tree persons, e.g. profiles of individuals in an existing genealogical research service or database, and may be added manually by one or more users or automatically by the network-task generation service 510 as suitable. For example, a user may begin adding a plurality of members to a people section 610 of a newly generated network, and the network-task generation service 510 may extend the people section 610 based on affiliations detected between the added plurality of members. As seen, the people section 610 of the user interface 600 may provide options for assigning tags or other metadata to members, accessing automatedly generated hints or notifications regarding members, searching for records or other details related to particular members, and other options as suitable.

A tasks section 620 may be provided to facilitate user engagement and historical research. While the tasks section 620 is depicted as a sidebar, it will be appreciated that the tasks section 620 may be provided in any suitable manner, and may be integrated into other sections of the network user interface 600. The tasks section 620 may include status updates and/or status indicia regarding discrete tasks such as adding members/people, uploading images, and/or identifying records related to the network and members thereof, for example. In embodiments, the status indicia may be configured to intuitively guide a user through steps for establishing a historical network.

Turning now to FIG. 6B, the tasks section 620 may transition from a first instantiation as seen in FIG. 6A, with a list of tasks and status updates, to a second instantiation 622 in which a user may select an option 625 to explore, using the network-task generation service 510, additional tasks that would further the research into the network using the embodiments. Upon selecting the option 625, the user may be prompted by the user interface 600 to enter additional details regarding the network. For example, the user interface 600 may be adapted to prompt the user to enter details that are detected to be missing from the network, such as a time frame that the network covers, a location that the network centers around, etc. In embodiments, a preliminary assessment of the network is conducted by the network-task generation service 510 based on the attached members, media, records, etc., and further details are solicited from the user based on the preliminary assessment.

Turning now to FIG. 6C, a third instantiation of the user interface tasks section is shown, in which the tasks section 630 receives from the network-task generation service 510 generated tasks for furthering historical research pertaining to the network, said tasks having been generated using engineered prompts from the data science module 520 and the LLM module 530 based on inputs structured based on content from the network. This may take the form of, for example, recommending that users identify key education institutions, research particular census records, or otherwise. In embodiments, recommended record searches in pertinent content collections are performed by the network-task generation service 510 with top-ranked results provided to the user in the user interface.

By providing a historical-network research-tasks generation system, method, and/or computer-program product, the problem of affiliations- and downstream historical-research insights-being heretofore impossible to determine for groups of people who are not connected by familial relationships, is advantageously addressed. The embodiments provide improved systems, methods, and computer-program products for detecting a network among a plurality of individuals; assessing an extent of historical research therebetween; and ranking a plurality of historical-research task suggestions based on the assessed historical research for and/or between a subset of the plurality of individuals.

As previously mentioned, the network-function generation system 100 provides a plurality of network functions based on a historical network. In particular, the network-function generation system 100 provides the plurality of network functions within a historical-network user interface. FIGS. 7A-7H illustrate example graphical user interfaces of the network-function generation system 100 providing and executing network functions, in accordance with one or more embodiments.

As shown in FIG. 7A, the network-function generation system 100 provides a historical-network user interface 700 that displays information related to a non-familial historical social network. For example, the network-function generation system 100 provides displays of various interface elements that visually represent a network name 702, network classification 704 (e.g., tag), network overview 706, suggested classifications 708 generated by the network-function generation system 100, a set of persons 710 associated with the historical network (including a name 711 and tag/role 712 for each of a plurality of members 713), within the historical-network user interface 700. In some cases, selecting an interface element will cause the network-function generation system 100 to provide additional information and/or options corresponding to the interface element, such as an option to edit or supplement information stored about the historical network, present genealogical records and/or content items associated with the historical network, provide additional details about an individual associated with the interface element (e.g., locations lived, important dates), and/or surface content items (e.g., pictures, digital historical records) or other information stored that corresponds to the interface element.

As illustrated, the historical-network user interface 700 further includes a panel 714 to collect additional contextual data about the historical network. Thus, the network-function generation system 100 can receive, via the historical-network user interface 700, additional historical-network contextual data from the client device. For example, the panel 714 includes interface elements 716 that facilitate input of a date range and geographic location associated with the historical network. The panel 714 further includes a selectable interface element (e.g., an option 718) associated with providing recommendations for the historical network. For example, in one or more embodiments, the network-function generation system 100 receives a user input selecting the option 718 as a network-function generation request. Thus, in response to receiving the selection of the option 718, the network-function generation system 100 can generate network functions based on historical-network contextual data as described herein.

As illustrated in FIG. 7B, in response to a user selection of option 718, the network-function generation system 100 displays panel 720 that displays a visual representation plurality of network functions including, for example, a visual representation of a network function 722. Thus, as mentioned, the network-function generation system 100 can provide for display (e.g., via the historical-network user interface 700), a visual representation network functions generated based on historical-network contextual data.

In particular, the visual representation of the network function 722 includes a title and descriptive text generated by the network-function generation system 100. For example, the network-function generation system 100 can generate the title and descriptive text by the LLM. For example, the title can include a text phrase based on the network function. For example, for a historical network based on a religious group in North Carolina in 1900-1920, the titles of the network functions could include “Identify religious denominations in North Carolina (1900-1920),” “Locate church records for identified denominations,” “Cross-reference religious records with census data,” “Investigate religious schools and institutions,” and “Analyze religious publications and newsletters.” The descriptive text can include, for example, a longer textual description related to the network functions—for example, “Research and list the predominant religious denominations in North Carolina during the period of 1900-1920. This will help focus your search on relevant religious records.”

In some cases, the panel 720 includes a selectable option 724 that, based on a user selection, indicate a user selection to view a collection of genealogical content items associated with the network function 722. The panel 720 further includes a selectable option 726 that, based on a user selection, indicate a user selection to store the network function 722 for future use/view in connection with the user account. The panel 720 further includes a selectable option 728 that, based on a user selection, indicate a user selection to execute the network function 722.

As mentioned, the network-function generation system 100 can provide a ranked list of collections of genealogical content items relevant to a network function. For example, as illustrated in FIG. 7C, in response to a selection of the selectable option 724, the network-function generation system 100 provides a panel 730 that depicts a visual representation of a set of collections of genealogical content items relevant to the network function 722. For example, as mentioned, the network-function generation system 100 can retrieve genealogical content items relevant to a network function based on vector representations of the network function and the genealogical content items.

As further illustrated in FIG. 7C, panel 730 indicates a visual representation of a ranked list 732 of genealogical content items. For example, the ranked list 732 can represent the collections of genealogical content items most relevant to the network function 722. The visual representation of the ranked list 732 includes, for example, further selectable options to view the associated collection of genealogical content items (e.g., receipt of a user input causes the network-function generation system 100 to provide the collection for display on the client device). For example, the ranked list 732 includes a selectable option 734 that, based on a user selection, indicate a user selection to view a “Collection B” of genealogical content items.

As illustrated in FIG. 7D, in response to a selection of selectable option 734, the network-function generation system 100 provides a search interface 740 for a search of genealogical content items related to the selected collection, “Collection B.” For instance, the network-function generation system 100 executes a search for “Collection B” among genealogical content items stored in a database. The network-function generation system 100 can further provide, for display, search results based on selection of the “Collection B” from among the ranked list 732.

As further illustrated in FIG. 7D, the search interface 740 includes a search query bar 742 and a set of search results 744. In some embodiments, the network-function generation system 100 retrieves genealogical content items relevant to the selected collection from the ranked list 732. For example, the set of search results 744 can include genealogical content items related to the network function 722—e.g., related to the selected collection, “Collection B.” In some embodiments, the network-function generation system 100 further provides additional interface elements to facilitate review of genealogical content items (e.g., from the set of search results 744), optionally based on receiving further input from the client device. For instance, as illustrated, in some embodiments, the search interface 740 includes a preview panel 746 displaying a preview 747 of a genealogical content item from the collection. In some embodiments, the network-function generation system 100 receives user input associated with a visual representation of a network function, and responsive to receiving the input, stores a network function to a user account of the genealogical data system. For example, returning to the historical-network user interface 700, as illustrated in FIG. 7E, in response to a selection of the selectable option 726, the network-function generation system 100 provides a panel 750 that depicts interface elements for storing the network function 722 for the user account. For example, panel 750 indicates an interface element 752 selectable to receive input (e.g., text) to store as a title, an interface element 754 selectable to receive input (e.g., text) to store as a description, an interface element 756 selectable to receive input to associate the network function 722 with a person from a genealogical tree, and an interface element 757 selectable to receive input to store the network function 722 for the user account.

As mentioned, in some cases, the network-function generation system 100 generates a sequence of network functions for execution according to an order. In some cases, the network-function generation system 100 can generate corresponding notifications for surfacing in an interface to guide a user through the sequence of network functions (e.g., in cases where the system does not self-execute the network functions). In particular, the network-function generation system 100 can interactively generate and provide selectable options and other interface elements to iteratively guide a user through a sequence of network functions. FIGS. 7F-7H illustrate the network-function generation system 100 generating and providing an exemplary sequence of interface elements to guide a user through a sequence of network functions to accomplish a target historical network objective.

For example, as illustrated in FIG. 7F, in response to a selection of the selectable option 728, the network-function generation system 100 can execute the network function 722. For instance, the network function 722 can be a first network function in the sequence of network functions—e.g., to perform a search for a particular genealogical content item or collection of genealogical content item. For example, in response to a selection of the selectable option 728, the network-function generation system 100 provides a search interface 760 for a search of genealogical content items related to the network function 722. As illustrated, the search interface 760 includes a search query bar 762.

As mentioned, the network-function generation system 100 can generate and provide notifications for surfacing in an interface to guide a user through a sequence of network functions. For instance, the network-function generation system 100 can provide a notification of a suggestion for a search of genealogical content items based on the network function 722. For example, as further illustrated in FIG. 7F, the search interface 760 includes an assistance panel 764 displaying a visual representation 766 of a suggested search prompt. In some cases, the network-function generation system 100 generates the suggested search prompt based on the network function 722 and/or the historical-network contextual data. For instance, the visual representation 766 can provide a notification with an instruction to input the suggested search prompt into the search query bar 762 and/or a request to confirm that the network-function generation system 100 should input the suggested search prompt into the search query bar 762.

The network-function generation system 100 can receive further input from the client device based on the notification—for example, receive an input of a search query based on the notification (e.g., as depicted in the visual representation 766). Based on receiving further input, the network-function generation system 100 can execute additional network functions, and generate and provide additional notifications. For instance, as illustrated in FIG. 7G, in response to receiving a search query based on the suggested search prompt (e.g., via input and/or confirmation from the client device), the network-function generation system 100 can execute a search based on the suggested search prompt and provide search results via the search interface 760. For example, the network-function generation system 100 provides selectable options 765 for a set of search results. For example, the search results can include genealogical content items relevant to the suggested search prompt.

As further illustrated in FIG. 7G, the network-function generation system 100 generates, based on the search results, a visual representation 767 of a further notification (e.g., a review suggestion indicating one or more search results). For example, the visual representation 767 depicts a a suggestion or prompt to review a particular search results from the search results. For instance, the network-function generation system 100 can generate the review suggestion based on comparing the search results to the network function 722 and/or historical-network contextual data.

Based on receiving further user input, the network-function generation system 100 can execute further network functions and surface additional notifications to further guide the user. For example, as illustrated in FIG. 7H, in response to receiving a selection of a selectable option from the selectable options 765, the network-function generation system 100 can provide a review interface 770 for a search result. For example, the search result is a genealogical content item relevant to the search. As shown, the review interface 770 includes a preview 772 to display a genealogical content item associated with a search result.

As further shown in FIG. 7H, the review interface 770 further includes a visual representation 774 of a review suggestion. For example, the visual representation 774 can highlight or indicate a portion of a genealogical content item for review. For example, the network-function generation system 100 can generate the review suggestion based on comparing the genealogical content item to the network function 722 and/or historical-network contextual data. The network-function generation system 100 can further continue the iterative, interactive process of receiving user input, executing network functions, generating and surfacing notifications related to further network functions. In this way, the network-function generation system 100 can execute network functions to accomplish a historical network research objective.

FIG. 8 illustrates a genealogical data system 800 (e.g., the genealogical data system 106) interfacing with a genealogical database 802 in accordance with one or more embodiments. For certain genealogical databases, the genealogical data system 800 identifies groups of user nodes or records in the format of a genealogical tree or records connected by biological and other family relationships as “tree data.” The genealogical data system 800 can thus search and process tree data stored in a genealogical database 802 (which includes a tree database 812 and a cluster database 814) to execute tasks and perform functions as described herein.

For the genealogical database 802, the genealogical data system 800 may receive genealogical data (e.g., data records and/or genealogical data objects) for building tree data from a source selected from a ground-truth genealogical tree generated from genealogical records and trees of user accounts within the genealogical data system 800, from the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and a motor vehicle database. Additionally, genealogical data can be user-generated. Genealogical data may also include data from a cluster database 814 derived from records and user data.

Some embodiments of the network-function generation system 100 relate to modifying a cluster database 814 based on a user query and/or other interaction with the network-function generation system 100. In some instances, the genealogical data system 800 (or the network-function generation system 100) determines and/or modifies a node connection for an individual represented by or resolved to a cluster within the cluster database 814. Indeed, the network-function generation system 100 can analyze, add, remove, and/or modify genealogical content items organized into clusters within the cluster database 814 based on relatedness corresponding to a common individual. The network-function generation system 100 can also access, modify, and analyze genealogical trees within the tree database 812 by, for example, adding nodes, removing nodes, and/or modifying nodes based genealogical content items (and their relationships to individuals) stored within the cluster database 814.

As seen in FIG. 8, the genealogical data system 800 includes a genealogical database 802, which may include a tree database 812 and a cluster database 814. The tree database 812 may be configured to facilitate the generation, storage, and collation of family trees for a plurality of users, with trees comprising nodes and edges therebetween. Data and records, such as images, may be associated with individual nodes of the trees in the tree database 812. Tree person data, including data such as names, relationships, dates, events, and other metadata may be provided by the tree database 812 to the genealogical data system 800. The cluster database 814 may include one or more clusters comprising resolved entities, where tree persons (nodes) in different trees in the tree database 812 are associated together in a cluster after determination that the tree persons correspond to a same person.

As a user expands their family tree, the tree database 812 may be modified as the user's family tree is expanded, and the cluster database 814 may be modified to include the new node in the pertinent cluster. Further, the network-function generation system 100 can modify the cluster database 814 and/or tree database 812 to include an edge connecting two nodes (e.g., tree persons) based on association through a non-familial historical social network, e.g., as identified based on execution of one or more network functions. For example, the network-function generation system 100 can extract or otherwise pull identifiers of persons of a historical social network, identify a tree person associated with the identifier, and update a node or a cluster of the cluster database 814 and/or tree database 812 to indicate connection to another node or cluster based on the historical social network (e.g., between nodes or clusters that do not a have a familial connection) to utilize future operations within the genealogical data system 800 and/or the network-function generation system 100.

FIGS. 1-8 the corresponding text, and the examples provide a number of different systems and methods for generating responses using a genealogical autonomous-decision framework in accordance with one or more embodiments. In addition to the foregoing, implementations can also be described in terms of flowcharts comprising acts steps in a method for accomplishing a particular result. For example, FIG. 9 illustrates an example series of acts for generating responses using a genealogical autonomous-decision framework.

While FIG. 9 illustrates acts according to certain implementations, alternative implementations may omit, add to, reorder, and/or modify any of the acts shown in FIG. 9. The acts of FIG. 9 can be performed as part of a computer-implemented method. Alternatively, a non-transitory computer-readable medium can comprise instructions, that when executed by one or more processors, cause a computing device to perform the acts of FIG. 9. In still further implementations, a system can perform the acts of FIG. 9.

As illustrated, the series of acts 900 includes an act 902 of receiving historical-network contextual data corresponding to a non-familial historical network. Specifically, the act 902 can include receiving, from a client device displaying a historical-network user interface, historical-network contextual data corresponding to a non-familial historical network. Additionally, the series of acts 900 can include an act 904 of retrieving at least one genealogical content item. Specifically, the act 904 can include retrieving, using a network-function generator, at least one genealogical content item related to the historical-network contextual data. Further, the series of acts 900 can include an act 906 of generating a plurality of network functions. Specifically, the act 906 can include generating, using a large language model (LLM) agent associated with the network-function generator, a plurality of network functions specific to the historical-network contextual data. Moreover, the series of acts 900 can include an act 908 of providing a visual representation of the plurality of network functions. Specifically, the act 908 can include providing, for display on the client device, a visual representation of the plurality of network functions. In at least one embodiment, the series of acts 900 can include acts to perform any of the operations described in the following clauses:

Clause 1. A computer-implemented method comprising: receiving, from a client device displaying a historical-network user interface, historical-network contextual data corresponding to a non-familial historical network; retrieving, using a network-function generator, at least one genealogical content item related to the historical-network contextual data; generating, using a large language model (LLM) agent associated with the network-function generator, a plurality of network functions specific to the historical-network contextual data; and providing, for display on the client device, a visual representation of the plurality of network functions.

Clause 2. The computer-implemented method of clause 1, further comprising ranking, using the network-function generator, the plurality of network functions to identify a subset of network functions specific to a subset of the historical-network contextual data.

Clause 3. The computer-implemented method of any of clauses 1-2, further comprising ranking, using the network-function generator, the plurality of network functions to identify an ordered subset of network functions that, when executed in sequence, accomplish a network target objective.

Clause 4. The computer-implemented method of any of clauses 1-3, further comprising: providing, to the LLM agent, the at least one genealogical content item related to the historical-network contextual data; and generating, using the LLM agent, the plurality of network functions specific to the historical-network contextual data, based on the at least one genealogical content item.

Clause 5. The computer-implemented method of any of clauses 1-4, further comprising identifying one or more collections of genealogical content items relevant to a network function of the plurality of network functions; and providing, for display on the client device, a visual representation of the one or more collections of genealogical content items relevant to the network function.

Clause 6. The computer-implemented method of clause 5, further comprising: ranking, using the network-function generator, the one or more collections of genealogical content items based on relevance to the network function; and providing, for display on the client device, a visual representation of a ranked list of the one or more collections of genealogical content items.

Clause 7. The computer-implemented method of any of clauses 1-6, further comprising receiving, from the client device displaying the historical-network user interface, a network-function generation request; based on receiving the network-function generation request, generating, by the network-function generator, a network-function generation prompt; and providing the network-function generation prompt to the LLM agent along with the at least one genealogical content item related to the historical-network contextual data.

Clause 8. The computer-implemented method of any of clauses 1-7, further comprising receiving, from the client device, a selection of a network function of the plurality of network functions; and responsive to the selection, executing the network function.

Clause 9. The computer-implemented method of any of clauses 1-8, wherein the historical-network contextual data comprises one or more of: a location associated with the non-familial historical network, a date or date range associated with the non-familial historical network, one or more identifiers corresponding to persons of the non-familial historical network, a description of the non-familial historical network, or a classification of the non-familial historical network.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

Although this disclosure describes certain exemplary embodiments and examples of a network-function generation system, computer program product, and/or method, it nevertheless will be understood by those skilled in the art that the present disclosure extends beyond the specifically disclosed embodiments to other alternative embodiments and/or uses of the disclosure and obvious modifications and equivalents thereof. It is intended that the scope of the present disclosure should not be limited by the particular disclosed embodiments described above, and may be extended to other uses, approaches, and contexts of family tree-, genealogy-, and/or genetic-related applications.

FIG. 10 illustrates an example computer system 1000 comprising various hardware elements, in accordance with some embodiments of the present disclosure. The computer system 1000 may be incorporated into or integrated with devices described herein and/or may be configured to perform some or all of the steps of the methods provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

In the illustrated example, the computer system 1000 includes a communication module 1002, one or more processor(s) 1004, one or more input and/or output device(s) 1030, and a storage 1001 comprising instructions 1003 for implementing an image enhancement system and/or method according to the disclosure. The computer system 1000 may be implemented using various hardware implementations and embedded system technologies. For example, one or more elements of the computer system 1000 may be implemented as a field-programmable gate array (FPGA), such as those commercially available by XILINX®, INTEL®, or LATTICE SEMICONDUCTOR®, a system-on-a-chip (SoC), an application-specific integrated circuit (ASIC), an application-specific standard product (ASSP), a microcontroller, and/or a hybrid device, such as an SoC FPGA, among other possibilities.

The various hardware elements of the computer system 1000 may be communicatively coupled via the communication module 1002. While the communication module 1002 is illustrated as a single connection for purposes of clarity, it should be understood that the communication module 1002 may include various numbers and types of communication media for transferring data between pertinent components such as hardware elements. For example, the communication module 1002 may include one or more wires (e.g., conductive traces, paths, or leads on a printed circuit board (PCB) or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, the communication medium 1002 may include one or more buses connecting pins of the hardware elements of the computer system 1000. For example, the communication medium 1002 may include a bus that connects the processor(s) 1004 with the storage 1001, referred to as a system bus, and a bus that connects the storage 1001 with the input device(s) and/or output device(s) 1030, referred to as an expansion bus. The system bus may itself consist of several buses, including an address bus, a data bus, and a control bus. The address bus may carry a memory address from the processor(s) 1004 to the address bus circuitry associated with the storage 1001 in order for the data bus to access and carry the data contained at the memory address back to the processor(s) 1004. The control bus may carry commands from the processor(s) 1004 and return status signals from the storage 1001. Each bus may include multiple wires for carrying multiple bits of information and each bus may support serial or parallel transmission of data.

The processor(s) 1004 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal oxide-semiconductor field-effect transistor (MOSFET) construction. The processor(s) 1004 may include one or more multi-core processors, in which each core may read and execute program instructions concurrently with the other cores, increasing speed for programs that support multithreading.

The input device(s) 1030 may include one or more of various user input devices such as a mouse, a keyboard, a microphone, as well as various sensor input devices, such as an image capture device, a pressure sensor (e.g., barometer, tactile sensor), a temperature sensor (e.g., thermometer, thermocouple, thermistor), a movement sensor (e.g., accelerometer, gyroscope, tilt sensor), a light sensor (e.g., photodiode, photodetector, charge-coupled device), and/or the like. The input device(s) 1030 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

The output device(s) 1030 may include one or more of various devices that convert information into human-readable form, such as without limitation a display device, a speaker, a printer, a haptic or tactile device, and/or the like. The output device(s) 1030 may also include devices for writing to removable storage devices or other removable media, such as those described in reference to the input device(s). The output device(s) 1030 may also include various actuators for causing physical movement of one or more components. Such actuators may be hydraulic, pneumatic, electric, and may be controlled using control signals generated by the computer system 1000.

The communications subsystem 1010 may include hardware components for connecting the computer system 1000 to systems or devices that are located external to the computer system 1000, such as over a computer network. In various embodiments, the communications subsystem 1010 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 1002.11 device, a Wi-Fi device, a Wi-Max device, a cellular device), combinations thereof, or other suitable possibilities.

The storage 1001 may include the various data storage devices of the computer system 1000. For example, the storage 1001 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While the processor(s) 1004 and the storage 1001 are illustrated as being separate elements, it should be understood that the processor(s) 1004 may include varying levels of on-processor memory, such as processor registers and caches that may be utilized by a single processor or shared between multiple processors.

The storage 1001 may include a main memory, which may be directly accessible by the processor(s) 1004 via the memory bus of the communication module 1002. For example, the processor(s) 1004 may continuously read and execute instructions stored in the main memory. As such, various software elements may be loaded into the main memory so as to be read and executed by the processor(s) 1004 as illustrated in FIG. 10. Typically, the main memory is volatile memory, which loses all data when power is turned off and accordingly needs power to preserve stored data.

The main memory may further include a small portion of non-volatile memory containing software (e.g., firmware, such as BIOS) that is used for reading other software stored in the storage 1001 into the main memory. In some embodiments, the volatile memory of the main memory is implemented as RAM, such as dynamic random-access memory (DRAM), and the non-volatile memory of the main memory is implemented as read-only memory (ROM), such as flash memory, erasable programmable read-only memory (EPROM), or electrically erasable programmable read-only memory (EEPROM).

The computer system 1000 may include software elements, shown as being currently located within the main memory, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 1003, which are executable by the computer system 1000. In one example, such instructions 1003 may be received by the computer system 1000 using the communications subsystem 1010 (e.g., via a wireless or wired signal that carries the instructions 1003), carried by the communication module 1002 to the storage 1001, stored within the storage 1001, read into the main memory, and executed by the processor(s) 1004 to perform one or more steps of the described methods.

In another example, the instructions 1003 may be received by the computer system 1000 using the input device(s) 1030 (e.g., via a reader for removable media), carried by the communication module 1002 to the storage 1001, stored within the storage 1001, read into the main memory, and executed by the processor(s) 1004 to perform one or more steps of the described methods.

In some embodiments of the present disclosure, the instructions 1003 are stored on a computer-readable storage medium (or simply computer-readable medium). Such a computer-readable medium may be a hardware storage device that, compared to transmission media or carrier waves, is “non-transitory” and may therefore be referred to as a non-transitory computer-readable medium. In some cases, the non-transitory computer-readable medium may be incorporated within the computer system 1000. For example, the non-transitory computer-readable medium may be the storage 1001 and/or the cloud storage 1050 (as shown in FIG. 10).

In some cases, the non-transitory computer-readable medium may be separate from the computer system 1000. In one example, the non-transitory computer-readable medium may be a removable medium provided to the input device(s) 1030 (as shown in FIG. 10), such as those described in reference to the input device(s) 1030, with the instructions 1003 being read into the computer system 1000 from the input device(s) 1030. In another example, the non-transitory computer-readable medium may be a component of a remote electronic device, such as a mobile phone, that may wirelessly transmit a data signal that carries the instructions 1003 to the computer system 1000 and that is received by the communications subsystem 1010 (as shown in FIG. 10).

The instructions 1003 may take any suitable form to be read and/or executed by the computer system 1000. For example, the instructions 1003 may be source code (written in a human-readable programming language such as Java, C, C++, C#, Python), object code, assembly language, machine code, microcode, executable code, and/or the like. In one example, the instructions 1003 are provided to the computer system 1000 in the form of source code, and a compiler is used to translate the instructions 1003 from source code to machine code, which may then be read into the main memory for execution by the processor(s) 1004.

As another example, instructions 1003 are provided to the computer system 1000 in the form of an executable file with machine code that may immediately be read into the main memory for execution by processor(s) 1004. In various examples, the instructions 1003 may be provided to the computer system 1000 in encrypted or unencrypted form, compressed or uncompressed form, as an installation package or an initialization for a broader software deployment, among other possibilities.

In one aspect of the present disclosure, a system (e.g., the computer system 1000) is provided to perform methods in accordance with various embodiments of the present disclosure. For example, some embodiments may include a system comprising one or more processors (e.g., the processor(s) 1004) that are communicatively coupled to a non-transitory computer-readable medium (e.g., the storage 1001). The non-transitory computer-readable medium may have instructions (e.g., the instructions 1003) stored thereon that, when executed by the one or more processors, cause the one or more processors to perform the methods or aspects thereof as described in the various embodiments.

In another aspect of the present disclosure, a computer-program product that includes instructions (e.g., instructions 1003) is provided to perform methods in accordance with various embodiments of the present disclosure. The computer-program product may be tangibly embodied in a non-transitory computer-readable medium (e.g., the storage 1001). The instructions may be configured to cause one or more processors (e.g., the processor(s) 1004) to perform the methods or aspects thereof as described in the various embodiments.

In another aspect of the present disclosure, a non-transitory computer-readable medium (e.g., the storage 1001) is provided. The non-transitory computer-readable medium may have instructions (e.g., instructions 1003) stored thereon that, when executed by one or more processors (e.g., processor(s) 1004), cause the one or more processors to perform the methods or aspects thereof as described in the various embodiments.

FIG. 11 is a schematic diagram illustrating environment 1100 within which one or more implementations of the network-function generation system 100 can be implemented. For example, the network-function generation system 100 may be part of a genealogical data system 1102 (e.g., the genealogical data system 106). The genealogical data system 1102 may generate, store, manage, receive, and send digital content (such as genealogical content items). For example, genealogical data system 1102 may send and receive digital content to and from client devices 1106 by way of network 1104. In particular, genealogical data system 1102 can store and manage genealogical databases for various user accounts, historical records, and genealogical trees. In some embodiments, the genealogical data system 1102 can manage the distribution and sharing of digital content between computing devices associated with user accounts. For instance, the genealogical data system 1102 can facilitate a user account sharing a genealogical content item with another user account of genealogical data system 1102.

In particular, the genealogical data system 1102 can manage synchronizing digital content across multiple client devices 1106 associated with one or more user accounts. For example, a user may edit a digitized historical document or a node within a genealogical tree using client device 1106. The genealogical data system 1102 can cause client device 1106 to send the edited genealogical content to the genealogical data system 1102, whereupon the genealogical data system 1102 synchronizes the genealogical content on one or more additional computing devices.

As shown, the client device 1106 may be a desktop computer, a laptop computer, a tablet computer, an augmented reality device, a virtual reality device, a personal digital assistant (PDA), an in-or out-of-car navigation system, a handheld device, a smart phone or other cellular or mobile phone, or a mobile gaming device, other mobile device, or other suitable computing devices. The client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1104.

The network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access genealogical data system 1102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

Although the embodiments of the disclosure are adapted for providing systems, methods, and/or computer-program products configured for generating historical-network research tasks, it will be appreciated that the principles of the disclosure may be adapted to any suitable application of genealogical and/or genetic research, exploration, organization, and/or visualization.

In the foregoing description, various examples are described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

A better understanding of different embodiments of the disclosure may be had from the foregoing description read with the accompanying drawings in which like reference characters refer to like elements. While the disclosure is susceptible to various modifications and alternative constructions, certain illustrative embodiments are in the drawings and are described herein. It should be understood, however, there is no intention to limit the disclosure to the embodiments disclosed, but on the contrary, the intention covers all modifications, alternative constructions, combinations, and equivalents falling within the spirit and scope of the disclosure. Unless a term is defined in this disclosure to possess a described meaning, there is no intent to limit the meaning of such term, either expressly or indirectly, beyond its plain or ordinary meaning.

Reference characters are provided in the claims for explanatory purposes only and are not intended to limit the scope of the claims or restrict each claim limitation to the element in the drawings and identified by the reference character.

For ease of understanding the disclosed embodiments of systems, methods, and/or computer-program products configured for generating historical-network research tasks, certain modules and features are described independently. The modules and features may be synergistically combined in embodiments to provide systems, methods, and/or computer-program products configured for generating historical-network research tasks.

The figures (FIGS.) and the foregoing description relate to preferred embodiments by way of illustration only. One of skill in the art may recognize alternative embodiments of the structures and methods disclosed herein as viable alternatives that may be employed without departing from the principles of what is disclosed.

Reference is made herein in detail to several embodiments, examples of which are illustrated in the accompanying figures. It is noted that wherever practicable similar or like reference numbers may be used in the figures and may indicate similar or like functionality. The figures depict embodiments of the disclosed historical-network research-tasks generation systems (or methods) for purposes of illustration only. One skilled in the art will readily recognize from the foregoing description that alternative embodiments of the structures and methods illustrated herein may be employed without departing from the principles described herein.

It is to be understood that not necessarily all objects or advantages may be achieved under any embodiment of the disclosure. Those skilled in the art will recognize that the historical-network research-tasks generation system, computer program product, and/or method embodiments may be embodied or carried out, so they achieve or optimize one advantage or group of advantages as taught herein without necessarily achieving other objects or advantages as taught or suggested herein.

The skilled artisan will recognize the interchangeability of various disclosed features. Besides the variations described, other known equivalents for each feature can be mixed and matched by one of skill in this art to provide or utilize a historical-network research-tasks generation system, computer program product, and/or method under principles of the present disclosure. It will be understood by the skilled artisan that the features described may apply to other types of data, contexts, and/or models.

Although this disclosure describes certain exemplary embodiments and examples of a historical-network research-tasks generation system, computer program product, and/or method, it nevertheless will be understood by those skilled in the art that the present disclosure extends beyond the specifically disclosed embodiments to other alternative embodiments and/or uses of the disclosure and obvious modifications and equivalents thereof. It is intended that the scope of the present disclosure should not be limited by the particular disclosed embodiments described above, and may be extended to other uses, approaches, and contexts of family tree-, genealogy-, and/or genetic-related applications.

What is claimed is:

1. A computer-implemented method, comprising:
receiving, from a client device displaying a historical-network user interface, historical-network contextual data corresponding to a non-familial historical network;
retrieving, using a network-function generator, at least one genealogical content item related to the historical-network contextual data;
generating, using a large language model (LLM) agent associated with the network-function generator, a plurality of network functions specific to the historical-network contextual data; and
providing, for display on the client device, a visual representation of the plurality of network functions.

2. The computer-implemented method of claim 1, further comprising ranking, using the network-function generator, the plurality of network functions to identify a subset of network functions specific to a subset of the historical-network contextual data.

3. The computer-implemented method of claim 1, further comprising ranking, using the network-function generator, the plurality of network functions to identify an ordered subset of network functions that, when executed in sequence, accomplish a network target objective.

4. The computer-implemented method of claim 1, further comprising:
providing, to the LLM agent, the at least one genealogical content item related to the historical-network contextual data; and
generating, using the LLM agent, the plurality of network functions specific to the historical-network contextual data, based on the at least one genealogical content item.

5. The computer-implemented method of claim 1, further comprising:
identifying one or more collections of genealogical content items relevant to a network function of the plurality of network functions; and
providing, for display on the client device, a visual representation of the one or more collections of genealogical content items relevant to the network function.

6. The computer-implemented method of claim 5, further comprising:
ranking, using the network-function generator, the one or more collections of genealogical content items based on relevance to the network function; and
providing, for display on the client device, a visual representation of a ranked list of the one or more collections of genealogical content items.

7. The computer-implemented method of claim 1, further comprising:
receiving, from the client device displaying the historical-network user interface, a network-function generation request;
based on receiving the network-function generation request, generating, by the network-function generator, a network-function generation prompt; and
providing the network-function generation prompt to the LLM agent along with the at least one genealogical content item related to the historical-network contextual data.

8. The computer-implemented method of claim 1, further comprising:
receiving, from the client device, a selection of a network function of the plurality of network functions; and
responsive to the selection, executing the network function.

9. The computer-implemented method of claim 1, wherein the historical-network contextual data comprises one or more of: a location associated with the non-familial historical network, a date or date range associated with the non-familial historical network, one or more identifiers corresponding to persons of the non-familial historical network, a description of the non-familial historical network, or a classification of the non-familial historical network.

10. A system comprising:
at least one processor; and
at least one non-transitory computer-readable storage medium storing instructions that, when executed by the at least one processor, cause the system to:
receive, from a client device displaying a historical-network user interface, historical-network contextual data corresponding to a non-familial historical network;
retrieve, using a network-function generator, at least one genealogical content item related to the historical-network contextual data;
generate, using a LLM agent associated with the network-function generator, a plurality of network functions specific to the historical-network contextual data; and
provide, for display on the client device, a visual representation of the plurality of network functions.

11. The system of claim 10, further comprising instructions that, when executed by the at least one processor, cause the system to rank, using the network-function generator, the plurality of network functions to identify an ordered subset of network functions that, when executed in sequence, accomplish a network target objective.

12. The system of claim 10, further comprising instructions that, when executed by the at least one processor, cause the system to:
provide, to the LLM agent, the at least one genealogical content item related to the historical-network contextual data; and
generate, using the LLM agent, the plurality of network functions specific to the historical-network contextual data, based on the at least one genealogical content item.

13. The system of claim 10, further comprising instructions that, when executed by the at least one processor, cause the system to:
identify one or more collections of genealogical content items relevant to a network function of the plurality of network functions; and
provide, for display on the client device, a visual representation of the one or more collections of genealogical content items relevant to the network function.

14. The system of claim 13, further comprising instructions that, when executed by the at least one processor, cause the system to:
rank, using the network-function generator, the one or more collections of genealogical content items based on relevance to the network function; and
provide, for display on the client device, a visual representation of a ranked list of the one or more collections of genealogical content items.

15. The system of claim 10, further comprising instructions that, when executed by the at least one processor, cause the system to:
receive, from the client device displaying the historical-network user interface, a network-function generation request;
based on receiving the network-function generation request, generate, by the network-function generator, a network-function generation prompt; and
provide the network-function generation prompt to the LLM agent along with the at least one genealogical content item related to the historical-network contextual data.

16. A non-transitory computer-readable medium storing instructions that, when executed by at least one processor, cause a computer system to:
receive, from a client device displaying a historical-network user interface, historical-network contextual data corresponding to a non-familial historical network;
retrieve, using a network-function generator, at least one genealogical content item related to the historical-network contextual data;
generate, using a LLM agent associated with the network-function generator, a plurality of network functions specific to the historical-network contextual data; and
provide, for display on the client device, a visual representation of the plurality of network functions.

17. The non-transitory computer-readable medium of claim 16, further comprising instructions that, when executed by the at least one processor, cause the computing device to rank, using the network-function generator, the plurality of network functions to identify an ordered subset of network functions that, when executed in sequence, accomplish a network target objective.

18. The non-transitory computer-readable medium of claim 16, further comprising instructions that, when executed by the at least one processor, cause the computing device to:
provide, to the LLM agent, the at least one genealogical content item related to the historical-network contextual data; and
generate, using the LLM agent, the plurality of network functions specific to the historical-network contextual data, based on the at least one genealogical content item.

19. The non-transitory computer-readable medium of claim 16, further comprising instructions that, when executed by the at least one processor, cause the computing device to:
identify one or more collections of genealogical content items relevant to a network function of the plurality of network functions; and
provide, for display on the client device, a visual representation of the one or more collections of genealogical content items relevant to the network function.

20. The non-transitory computer-readable medium of claim 19, further comprising instructions that, when executed by the at least one processor, cause the computing device to:
rank, using the network-function generator, the one or more collections of genealogical content items based on relevance to the network function; and
provide, for display on the client device, a visual representation of a ranked list of the one or more collections of genealogical content items.
